(19) United States
(12) Patent Application Publication
(10) Pub. No.: US 2024/0100523 A1
(43) Pub. Date: Mar. 28, 2024

(54) DIGITAL MICROFLUIDICS CARTRIDGE, SYSTEM, AND METHOD

(71) Applicant: NICOYA LIFESCIENCES, INC., Kitchener (CA)

(72) Inventors: Gordon H. HALL, Milton (CA); Arjun SUDARSAN, Carlsbad, CA (US)

(21) Appl. No.: 18/263,745

(22) PCT Filed: Feb. 1, 2022
(86) PCT No.: PCT/CA2022/050146

§ 371 Date: Aug. 1, 2023

Related U.S. Application Data
(60) Provisional application No. 63/144,947, filed on Feb. 2, 2021.

(51) Int. Cl. B01L 3/00

(52) U.S. Cl. CPC B01L 3/502792; B01L 2200/025; B01L 2200/0689; B01L 2200/16; B01L 2300/044; B01L 2300/0672; B01L 2300/123; B01L 2400/0481

(57) ABSTRACT

A cartridge with (a) a top substrate and a bottom substrate separated to form a droplet operations gap, the top substrate comprising a well plate comprising an array of wells each well comprising a hollow needle liquidly connecting an interior of the well with the droplet operations gap; and (b) a compressible membrane layer atop the well plate sealing the reservoirs and arranged so that compression of the flexible membrane towards the interior of the well forces a liquid from the interior of the well through the hollow needle, and into the droplet operations gap.

### CROSS-REFERENCE TO RELATED APPLICATIONS

This application claims priority to U.S. Patent App. No. 63/144,947 filed on Feb. 2, 2021.

### FIELD OF THE INVENTION

The subject matter relates to dispensing liquids and more particularly to digital microfluidics (DMF) devices and methods for dispensing liquids using piercer features and compressible membranes.

### BACKGROUND OF THE INVENTION

A DMF cartridge (or device) typically includes one or more substrates with a gap therebetween. For example, the one or more substrates establish a droplet operations surface or gap for conducting droplet operations. The substrates may also include electrodes arranged to conduct the droplet operations. The droplet operations substrate or the gap between the substrates may be coated or filled with a filler liquid that is immiscible with the liquid that forms the droplets. Loading reagents and oil into a DMF cartridge has been highlighted as one of the most difficult steps in performing a DMF experiment. Accordingly, new approaches are needed with respect to loading liquids, such as sample liquid, reagents, and oil, into DMF cartridges.

### SUMMARY OF THE INVENTION

The disclosure provides a microfluidics cartridge. The cartridge may include a top substrate and a bottom substrate separated to form a droplet operations gap, the top substrate including a well plate including an array of wells each well including a hollow needle liquidly connecting an interior of the well with the droplet operations gap. The cartridge may include a compressible membrane layer atop the well plate sealing the reservoirs and arranged so that compression of the flexible membrane towards the interior of the well forces a liquid from the interior of the well through the hollow needle, and into the droplet operations gap.

The disclosure provides a system including a cartridge mounted on an instrument. The instrument may include processors, controllers, electronics, optics, and the like for interfacing with the cartridge. The instrument may include a means for compressing the flexible membrane. The means may be electrically coupled to and controlled by a computer processor of the instrument.

The cartridge may include a DMF portion including: a bottom substrate and a top substrate, each having a bottom surface and a top surface, wherein the top substrate contains one or more openings through which a liquid can flow; one or more pairs of piercer features extending upwards from the top surface of the top substrate, wherein the pair of piercer features are separated by a gap, thereby forming a flow channel therethrough, and wherein the flow channels are in substantial alignment with the openings; and a droplet operations gap interposed between the top surface of the bottom substrate and the bottom surface of the top substrate, thereby separating the bottom substrate and the top substrate to form a chamber in which droplet operations can be performed, wherein the flow channels are in liquid contact with the droplet operations gap via the openings.

The cartridge may include a well plate portion including: a compressible membrane layer having a top surface and a bottom surface, wherein the bottom surface is mounted on the top surface of the top substrate; and a well plate with a bottom surface and a top surface, wherein the bottom surface of the well plate is mounted on the top surface of the compressible membrane layer, and wherein the well plate contains one or more liquid wells and one or more sealed liquid compartments substantially in alignment with the piercer features of the top substrate.

In certain embodiments, the DMF component may include a bottom substrate and a top substrate, each having a bottom surface and a top surface, wherein the top substrate contains one or more openings through which a liquid can flow. The DMF component may include one or more pairs of piercer features extending upwards from the top surface of the top substrate, wherein each pair of piercer features are separated by a gap, thereby forming a flow channel therethrough, and wherein the flow channels are in substantial alignment with the openings. A droplet operations gap may be interposed between the top surface of the bottom substrate and the bottom surface of the top substrate, thereby separating the bottom substrate and the top substrate to form a chamber in which droplet operations can be performed, wherein the flow channels are in liquid contact with the droplet operations gap via the openings. The cartridge may include a first compressible membrane layer with a top surface and a bottom surface, wherein the bottom surface of the first compressible membrane later is mounted on top of the top surface of the top substrate. The invention may include a well plate component including: a second compressible membrane layer having a top surface and a bottom surface; and a well plate with a bottom surface and a top surface, wherein the bottom surface of the well plate is mounted on the top surface of the second compressible membrane layer. The DMF and well plate components may be mated to form a single operational cartridge. In some cases, the means for applying a compression force applies the compression force either to the well plate portion only, to the DMF portion only, or to the well plate portion and the DMF portion in opposition at substantially the same time. In some cases, the piercer features are arranged such that, upon actuation of the means for applying a compression force, application of the compression force causes the piercer features to pass upwards through the first and second compressible membrane layers and into the liquid wells, thereby allowing liquid to flow through the flow channels into the droplet operations gap via the openings, and simultaneously causes the piercer features to penetrate the seals of the sealed liquid compartments, thereby allowing liquid to flow through the flow channels into the droplet operations gap via the openings, and wherein the liquid is sealed within the droplet operations gap when the first and second compressible membrane layers are returned to their uncompressed states.

The DMF component may include a bottom substrate and a top substrate, each having a bottom surface and a top surface, wherein the top substrate contains one or more openings through which a liquid can flow, whereon at least one of the openings is larger than the other openings; one or more pairs of piercer features extending upwards from the top surface of the top substrate, wherein each pair of piercer features are separated by a gap, thereby forming a flow channel therethrough, and wherein the flow channels are in substantial alignment with the openings, and wherein at least one pair of piercer features is larger than the other piercer features; a droplet operations gap interposed between the top surface of the bottom substrate and the bottom surface of the top substrate, thereby separating the bottom substrate and the top substrate to form a chamber in which droplet operations can be performed, wherein the flow channels are in liquid contact with the droplet operations gap via the openings; and a first compressible membrane layer including a thick portion and a thin portion, each portion having a top surface and a bottom surface, and wherein the bottom surfaces of the thin portion and the thick portion are mounted on the top surface of the top substrate, a first compressible membrane layer including a thick portion and a thin portion, each portion having a top surface and a bottom surface, and wherein the bottom surfaces of the thin portion and the thick portion are mounted on the top surface of the top substrate, wherein the thick portion is substantially aligned with the larger piercer feature and the thin portion is substantially aligned with the other piercer features. The cartridge may include a well plate component including: a well plate with a bottom surface and a top surface, wherein the well plate may include liquid wells in liquid contact with the top surface of the second compressible membrane layer, wherein one of the liquid wells is substantially aligned with the larger piercer feature and may include a larger size, surface area, and volume that other liquid wells; and a second compressible membrane layer having a top surface and a bottom surface, wherein the top surface of the second compressible membrane layer is mounted on the bottom surface of the well plate. The DMF and well plate components may be mated to form a single operational cartridge.

The disclosure provides a digital microfluidics cartridge, which may include a bottom substrate and a top substrate, each having a bottom surface and a top surface, wherein the top substrate may include one or more liquid loading ports contained therein; and a droplet operations gap interposed between the top surface of the bottom substrate and the bottom surface of the top substrate, thereby separating the bottom substrate and the top substrate to form a chamber in which droplet operations can be performed, wherein the liquid loading ports are in liquid contact with the droplet operations gap; and a compressible membrane layer having a top surface and a bottom surface and including one or more hollow needle features each including an opening at the distal end of the hollow needle feature, wherein the hollow needle features protrude downward from the well plate portion and towards the DMF portion and wherein the openings are sealed while the compressible membrane layer is in an uncompressed state; and a well plate with a bottom surface and a top surface, wherein the well plate may include liquid wells in liquid contact with the hollow needle features, wherein the bottom surface of the well plate is in contact with the top surface of the compressible membrane layer and wherein the liquid wells are in substantial alignment with the hollow needle features and the liquid loading ports. Applying a compression force causes the hollow needle feature to pass through the compressible membrane layer and into the droplet operations gap, thereby permitting liquid to flow from the liquid wells into the droplet operations gap via the liquid loading ports, and wherein liquid is sealed within the droplet operations gap when the compressible membrane layer is returned to its uncompressed state.

The cartridge may include a DMF component including: a bottom substrate and a top substrate, each having a bottom surface and a top surface, wherein the top substrate may include one or more liquid loading ports contained therein; a droplet operations gap interposed between the top surface of the bottom substrate and the bottom surface of the top substrate, thereby separating the bottom substrate and the top substrate to form a chamber in which droplet operations can be performed, wherein the liquid loading ports are in liquid contact with the droplet operations gap; and a first compressible membrane layer with a top surface and a bottom surface, wherein the bottom surface of the first compressible membrane later is mounted on top of the top surface of the top substrate.

The cartridge may include a well plate component including: a second compressible membrane layer having a top surface and a bottom surface and including one or more hollow needle features each including an opening at the distal end of the hollow needle feature, wherein the hollow needle features protrude downward from the top surface of well plate component and wherein the openings are sealed while the second compressible membrane layer is in an uncompressed state; and a well plate with a bottom surface and a top surface, wherein the well plate may include an array of liquid wells in liquid contact with the hollow needle features, wherein the bottom surface of the well plate is in contact with the top surface of the second compressible membrane layer and wherein the liquid wells are in substantial alignment with the hollow needle features; wherein the DMF and well plate components are mated to form a single operational cartridge.

In various embodiments, the means for applying a compression force applies the compression force either to the well plate portion only, to the DMF portion only, or to the well plate portion and the DMF portion in opposition at substantially the same time.

In some cases, the sealed liquid compartments comprise pre-filled blister packs.

In some cases, liquid can be externally introduced into the liquid wells via a pipette.

In some cases, the liquid wells are pre-loaded with liquids, wherein the liquid is sealed within the liquid wells by a sealing membrane.

In some cases, one or more of the wells is pre-loaded with a liquid. The liquid may be sealed within the well by a sealing membrane. The liquid may, for example, be selected from a group consisting of sample liquids, reagents, buffer solutions, or low-viscosity oils.

The means for applying a compression force may include a pressure plate or membrane. The liquid may include a low-viscosity oil selected from a group consisting of a silicone oil or a hexadecane filler liquid.

In some cases, the droplet operations gap is pre-loaded with a low-viscosity oil.

The cartridge may include an adhesive bonding a bottom surface of the compressible membrane layer to a top surface of the top substrate and a top surface of the compressible membrane layer to a bottom surface of the well plate.

In some cases, the compressible membrane layer is from about 1 mm to about 25 mm thick when uncompressed and from about 0.7 mm to about 19 mm thick when compressed. In some cases, the hollow needle is from about 0.9 mm to about 20 mm in length. In some cases, the compressible membrane layer is composed of a rubber or elastomer compound.

In certain embodiments, the rubber or elastomer compound is selected from a group consisting of a natural rubber compound, a silicone rubber compound, butyl rubber compounds, ethylene propylene diene monomer (EPDM) compounds, nitrile rubber compounds, polychloroprene rubber compounds, fluorocarbon rubber compounds, and tetrafluoroethylene/propylene (TPE/P) rubber compounds.

The cartridge may be configured such that a compression force applied to the compressible membrane layer seals the wells while the compressible membrane layer is in a compressed state, thereby preventing the flow of liquid out of the droplet operations gap while the hollow needle is liquidly connected to the droplet operations gap.

In all of the embodiments described herein, the means for applying a first compression force and a second a compression force may be provided on the cartridge and/or on the instrument.

In some cases, the means for applying the first compression force applies a first compression force to the thick portion of the first compressible membrane layer and the second compression force applies a second compression force to the thin portion of the first compression membrane layer.

In some cases, in a first actuation stage, the larger piercer feature is arranged such that, upon actuation of the means for applying a first compression force and a second compression force, application of the first compression force causes the larger piercer feature to pass upwards through the thick portion of the first compressible membrane layer and the second compressible membrane layer and into the larger liquid well, thereby allowing liquid to flow through the flow channel into the droplet operations gap via the opening, and wherein in a second actuation stage, the other piercer features are arranged such that, upon actuation of the means for applying a first compression force and a second compression force, application of the second compression force causes the other piercer features to pass upwards through the thin portion of the first compression membrane layer and the second compression membrane layer and into other liquid wells, thereby allowing liquid to flow through the flow channels into the droplet operations gap via the openings. Liquid may be sealed within the droplet operations gap when the DMF component and the well plate component of the single operational cartridge are separated.

The disclosure provides a method for filling a cartridge as described herein, e.g., by providing the cartridge; supplying the liquid wells with liquid to be processed; actuating a first liquid dispensing operation by applying the first compression force; actuating a second liquid dispensing operation by applying the second compression force; and suspending liquid dispensing operations by removing compression forces from the two-component cartridge.

### BRIEF DESCRIPTION OF THE DRAWINGS

The features and advantages of the present invention will be more clearly understood from the following description taken in conjunction with the accompanying drawings, which are not necessarily drawn to scale.

FIG. 1 through FIG. 5 are side views of an example of a DMF device including well-plate piercer features embedded in a compressible membrane and a process of using the same.

FIG. 6 through FIG. 11 are side views of an example of a two-piece DMF device including well-plate piercer features embedded in a compressible membrane and a process of using the same.

FIG. 12 is a flow diagram of an example of a method of dispensing liquid using the DMF devices shown in FIG. 1 through FIG. 11.

FIG. 13 through FIG. 16 are side views of an example of a DMF device including DMF piercer features embedded in a compressible membrane and a process of using the same.

FIG. 17 through FIG. 19 are side views of an example of a two-piece DMF device including DMF piercer features embedded in a compressible membrane and a process of using the same.

FIG. 20 is a flow diagram of an example of a method of dispensing liquid using the DMF devices shown in FIG. 13 through FIG. 19.

FIG. 21 through FIG. 25 are side views of an example of a two-piece DMF device including DMF piercer features embedded in a compressible membrane and a two-stage actuation process.

FIG. 26 is a flow diagram of an example of a method of dispensing liquid using the two-piece DMF device shown in FIG. 21 through FIG. 25.

FIG. 27 is a side view of an example of a DMF device configured for two-stage dispensing using a single-stage actuation process.

FIG. 28, FIG. 29, and FIG. 30 are side views of an example of a two-piece DMF device including DMF piercer features embedded in a compressible membrane and a process of using the same.

FIG. 31 through FIG. 36 are side views of an example of a two-piece DMF device including DMF piercer features embedded in a compressible membrane and wherein the two-piece DMF device may be configured for maintaining an airtight DMF environment.

FIG. 37 through FIG. 40 are side views of an example of a DMF device including DMF piercer features embedded in a compressible membrane and wherein the compressible membrane may be used for aspirating liquid instead of dispensing liquid.

### DETAILED DESCRIPTION OF THE EMBODIMENTS

### 1.1. Definitions

“Activate,” with reference to one or more electrodes, means affecting a change in the electrical state of the one or more electrodes which, in the presence of a droplet, results in a droplet operation. Activation of an electrode can be accomplished using alternating current (AC) or direct current (DC). Any suitable voltage may be used. For example, an electrode may be activated using a voltage which is greater than about 5 V, or greater than about 20 V, or greater than about 40 V, or greater than about 100 V, or greater than about 200 V or greater than about 300 V. The suitable voltage being a function of the dielectric's properties such as thickness and dielectric constant, liquid properties such as viscosity and many other factors as well. Where an AC signal is used, any suitable frequency may be employed. For example, an electrode may be activated using an AC signal having a frequency from about 1 Hz to about 10 MHz, or from about 1 Hz and 10 KHz, or from about 10 Hz to about 240 Hz, or about 60 Hz.

“Droplet” means a volume of liquid on a droplet actuator. Typically, a droplet is at least partially bounded by a filler liquid. For example, a droplet may be surrounded by a filler liquid or may be bounded by filler liquid and one or more surfaces of the droplet actuator. As another example, a droplet may be bounded by filler liquid, one or more surfaces of the droplet actuator, and/or the atmosphere. In yet another example, a droplet may be bounded by filler liquid and the atmosphere. Droplets may, for example, be aqueous or non-aqueous or may be mixtures or emulsions including aqueous and non-aqueous components. Droplets may take a wide variety of shapes; non-limiting examples include generally disc shaped, slug shaped, truncated sphere, ellipsoid, spherical, partially compressed sphere, hemispherical, ovoid, cylindrical, combinations of such shapes, and various shapes formed during droplet operations, such as merging or splitting or formed as a result of contact of such shapes with one or more surfaces of a droplet actuator. For examples of droplet liquids that may be subjected to droplet operations using the approach of the invention, see International Patent Application No. PCT/US 06/47486, entitled, “Droplet-Based Biochemistry,” filed on Dec. 11, 2006.

In various embodiments, a droplet may include a biological sample, such as whole blood, lymphatic liquid, serum, plasma, sweat, tear, saliva, sputum, cerebrospinal liquid, amniotic liquid, seminal liquid, vaginal excretion, serous liquid, synovial liquid, pericardial liquid, peritoneal liquid, pleural liquid, transudates, exudates, cystic liquid, bile, urine, gastric liquid, intestinal liquid, fecal samples, liquids containing single or multiple cells, liquids containing organelles, liquidized tissues, liquidized organisms, liquids containing multi-celled organisms, biological swabs and biological washes. Moreover, a droplet may include a reagent, such as water, deionized water, saline solutions, acidic solutions, basic solutions, detergent solutions and/or buffers.

Other examples of droplet contents include reagents, such as a reagent for a biochemical protocol, such as a nucleic acid amplification protocol, an affinity-based assay protocol, an enzymatic assay protocol, a sequencing protocol, and/or a protocol for analyses of biological liquids. A droplet may include one or more beads.

“Droplet Actuator” means a device for manipulating droplets. For examples of droplet actuators, see Pamula et al., U.S. Pat. No. 6,911,132, entitled “Apparatus for Manipulating Droplets by Electrowetting-Based Techniques,” issued on Jun. 28, 2005; Pamula et al., U.S. patent application Ser. No. 11/343,284, entitled “Apparatuses and Methods for Manipulating Droplets on a Printed Circuit Board,” filed on filed on Jan. 30, 2006; Pollack et al., International Patent Application No. PCT/US2006/047486, entitled “Droplet-Based Biochemistry,” filed on Dec. 11, 2006; Shenderov, U.S. Pat. No. 6,773,566, entitled “Electrostatic Actuators for Microfluidics and Methods for Using Same,” issued on Aug. 10, 2004 and U.S. Pat. No. 6,565,727, entitled “Actuators for Microfluidics Without Moving Parts,” issued on Jan. 24, 2000; Kim and/or Shah et al., U.S. patent application Ser. No. 10/343,261, entitled “Electrowetting-driven Micropumping,” filed on Jan. 27, 2003, Ser. No. 11/275,668, entitled “Method and Apparatus for Promoting the Complete Transfer of Liquid Drops from a Nozzle,” filed on Jan. 23, 2006, Ser. No. 11/460,188, entitled “Small Object Moving on Printed Circuit Board,” filed on Jan. 23, 2006, Ser. No. 12/465,935, entitled “Method for Using Magnetic Particles in Droplet Microfluidics,” filed on May 14, 2009, and Ser. No. 12/513,157, entitled “Method and Apparatus for Real-time Feedback Control of Electrical Manipulation of Droplets on Chip,” filed on Apr. 30, 2009; Velev, U.S. Pat. No. 7,547,380, entitled “Droplet Transportation Devices and Methods Having a Liquid Surface,” issued on Jun. 16, 2009; Sterling et al., U.S. Pat. No. 7,163,612, entitled “Method, Apparatus and Article for Microfluidic Control via Electrowetting, for Chemical, Biochemical and Biological Assays and the Like,” issued on Jan. 16, 2007; Becker and Gascoyne et al., U.S. Pat. No. 7,641,779, entitled “Method and Apparatus for Programmable fluidic Processing,” issued on Jan. 5, 2010, and U.S. Pat. No. 6,977,033, entitled “Method and Apparatus for Programmable fluidic Processing,” issued on Dec. 20, 2005; Decre et al., U.S. Pat. No. 7,328,979, entitled “System for Manipulation of a Body of Liquid,” issued on Feb. 12, 2008; Yamakawa et al., U.S. Patent Pub. No. 20060039823, entitled “Chemical Analysis Apparatus,” published on Feb. 23, 2006; Wu, International Patent Pub. No. WO/2009/003184, entitled “Digital Microfluidics Based Apparatus for Heat-exchanging Chemical Processes,” published on Dec. 31, 2008; Fouillet et al., U.S. Patent Pub. No. 20090192044, entitled “Electrode Addressing Method,” published on Jul. 30, 2009; Fouillet et al., U.S. Pat. No. 7,052,244, entitled “Device for Displacement of Small Liquid Volumes Along a Micro-catenary Line by Electrostatic Forces,” issued on May 30, 2006; Marchand et al., U.S. Patent Pub. No. 20080124252, entitled “Droplet Microreactor,” published on May 29, 2008; Adachi et al., U.S. Patent Pub. No. 20090321262, entitled “Liquid Transfer Device,” published on Dec. 31, 2009; Roux et al., U.S. Patent Pub. No. 20050179746, entitled “Device for Controlling the Displacement of a Drop Between two or Several Solid Substrates,” published on Aug. 18, 2005; Dhindsa et al., “Virtual Electrowetting Channels: Electronic Liquid Transport with Continuous Channel Functionality,” Lab Chip, 10:832-836 (2010); the entire disclosures of which are incorporated herein by reference, along with their priority documents.

Certain droplet actuators will include one or more substrates arranged with a droplet operations gap therebetween and electrodes associated with (e.g., layered on, attached to, and/or embedded in) the one or more substrates and arranged to conduct one or more droplet operations. For example, certain droplet actuators will include a base (or bottom) substrate, droplet operations electrodes associated with the substrate, one or more dielectric layers atop the substrate and/or electrodes, and optionally one or more hydrophobic layers atop the substrate, dielectric layers and/or the electrodes forming a droplet operations surface.

A top substrate may also be provided, which is separated from the droplet operations surface by a gap, commonly referred to as a droplet operations gap. Various electrode arrangements on the top and/or bottom substrates are discussed in the above-referenced patents and applications and certain novel electrode arrangements are discussed in the description of the invention.

During droplet operations it is preferred that droplets remain in continuous contact or frequent contact with a ground or reference electrode.

A ground or reference electrode may be associated with the top substrate facing the gap, the bottom substrate facing the gap, in the gap. Where electrodes are provided on both substrates, electrical contacts for coupling the electrodes to a droplet actuator instrument for controlling or monitoring the electrodes may be associated with one or both plates.

In some cases, electrodes on one substrate are electrically coupled to the other substrate so that only one substrate is in contact with the droplet actuator. In one embodiment, a conductive material (e.g., an epoxy, such as MASTER BOND™ Polymer System EP79, available from Master Bond, Inc., Hackensack, NJ) provides the electrical connection between electrodes on one substrate and electrical paths on the other substrates, e.g., a ground electrode on a top substrate may be coupled to an electrical path on a bottom substrate by such a conductive material.

Where multiple substrates are used, a spacer may be provided between the substrates to determine the height of the gap therebetween and define on-actuator dispensing reservoirs. The spacer height may, for example, be from about 5 μm to about 1000 μm, or about 100 μm to about 400 μm, or about 200 μm to about 350 μm, or about 250 μm to about 300 μm, or about 275 μm. The spacer may, for example, be formed of a layer of projections form the top or bottom substrates, and/or a material inserted between the top and bottom substrates.

One or more openings may be provided in the one or more substrates for forming a liquid path through which liquid may be delivered into the droplet operations gap. The one or more openings may in some cases be aligned for interaction with one or more electrodes, e.g., aligned such that liquid flowed through the opening will come into sufficient proximity with one or more droplet operations electrodes to permit a droplet operation to be affected by the droplet operations electrodes using the liquid.

The base (or bottom) and top substrates may in some cases be formed as one integral component.

One or more reference electrodes may be provided on the base (or bottom) and/or top substrates and/or in the gap. Examples of reference electrode arrangements are provided in the above referenced patents and patent applications.

In various embodiments, the manipulation of droplets by a droplet actuator may be electrode mediated, e.g., electrowetting mediated or dielectrophoresis mediated or Coulombic force mediated. Examples of other techniques for controlling droplet operations that may be used in the droplet actuators of the invention include using devices that induce hydrodynamic fluidic pressure, such as those that operate on the basis of mechanical principles (e.g. external syringe pumps, pneumatic membrane pumps, vibrating membrane pumps, vacuum devices, centrifugal forces, piezoelectric/ultrasonic pumps and acoustic forces); electrical or magnetic principles (e.g. electroosmotic flow, electrokinetic pumps, ferrofluidic plugs, electrohydrodynamic pumps, attraction or repulsion using magnetic forces and magnetohydrodynamic pumps); thermodynamic principles (e.g. gas bubble generation/phase-change-induced volume expansion); other kinds of surface-wetting principles (e.g. electrowetting, and optoelectrowetting, as well as chemically, thermally, structurally and radioactively induced surface-tension gradients); gravity; surface tension (e.g., capillary action); electrostatic forces (e.g., electroosmotic flow); centrifugal flow (substrate disposed on a compact disc and rotated); magnetic forces (e.g., oscillating ions causes flow); magnetohydrodynamic forces; and vacuum or pressure differential.

In certain embodiments, combinations of two or more of the foregoing techniques may be employed to conduct a droplet operation in a droplet actuator of the invention. Similarly, one or more of the foregoing may be used to deliver liquid into a droplet operations gap, e.g., from a reservoir in another device or from an external reservoir of the droplet actuator (e.g., a reservoir associated with a droplet actuator substrate and a flow path from the reservoir into the droplet operations gap).

Droplet operations surfaces of certain droplet actuators of the invention may be made from hydrophobic materials or may be coated or treated to make them hydrophobic. For example, in some cases some portion or all the droplet operations surfaces may be derivatized with low surface-energy materials or chemistries, e.g., by deposition or using in situ synthesis using compounds such as poly- or per-fluorinated compounds in solution or polymerizable monomers. Examples include TEFLON® AF (available from DuPont, Wilmington, DE), members of the cytop family of materials, coatings in the FLUOROPEL® family of hydrophobic and superhydrophobic coatings (available from Cytonix Corporation, Beltsville, MD), silane coatings, fluorosilane coatings, hydrophobic phosphonate derivatives (e.g., those sold by Aculon, Inc), and NOVEC™ electronic coatings (available from 3M Company, St. Paul, MN), other fluorinated monomers for plasma-enhanced chemical vapor deposition (PECVD), and organosiloxane (e.g., SiOC) for PECVD.

In some cases, the droplet operations surface may include a hydrophobic coating having a thickness ranging from about 10 nm to about 1,000 nm.

Moreover, in some embodiments, the top substrate of the droplet actuator includes an electrically conducting organic polymer, which is then coated with a hydrophobic coating or otherwise treated to make the droplet operations surface hydrophobic. For example, the electrically conducting organic polymer that is deposited onto a plastic substrate may be poly(3,4-ethylenedioxythiophene) poly(styrenesulfonate) (PEDOT:PSS).

Other examples of electrically conducting organic polymers and alternative conductive layers are described in Pollack et al., International Patent Application No. PCT/US2010/040705, entitled “Droplet Actuator Devices and Methods,” the entire disclosure of which is incorporated herein by reference. One or both substrates may be fabricated using a printed circuit board (PCB), glass, indium tin oxide (ITO)-coated glass, and/or semiconductor materials as the substrate. When the substrate is ITO-coated glass, the ITO coating is preferably a thickness in the range of about 20 to about 200 nm, preferably about 50 to about 150 nm, or about 75 to about 125 nm, or about 100 nm.

In some cases, the top and/or bottom substrate includes a PCB substrate that is coated with a dielectric, such as a polyimide dielectric, which may in some cases also be coated or otherwise treated to make the droplet operations surface hydrophobic. When the substrate includes a PCB, the following materials are examples of suitable materials: MITSUI™ BN-300 (available from MITSUI Chemicals America, Inc., San Jose CA); ARLON™ 11N (available from Arlon, Inc, Santa Ana, CA).; NELCO® N4000-6 and N5000-30/32 (available from Park Electrochemical Corp., Melville, NY); ISOLA™ FR406 (available from Isola Group, Chandler, AZ), especially IS620; fluoropolymer family (suitable for fluorescence detection since it has low background fluorescence); polyimide family; polyester; polyethylene naphthalate; polycarbonate; polyetheretherketone; liquid crystal polymer; cyclo-olefin copolymer (COC); cyclo-olefin polymer (COP); aramid; THERMOUNT® nonwoven aramid reinforcement (available from DuPont, Wilmington, DE); NOMEX® brand fiber (available from DuPont, Wilmington, DE); and paper. Various materials are also suitable for use as the dielectric component of the substrate.

Examples include: vapor deposited dielectric, such as PARYLENE™ C, PARYLENE™ N, PARYLENE™ F and PARYLENE™ HT (for high temperature, −300° C.) (available from Parylene Coating Services, Inc., Katy, TX); TEFLON® AF coatings; cytop; soldermasks, such as liquid photoimageable soldermasks (e.g., on PCB) like TAIYO™ PSR4000 series, TAIYO™ PSR and AUS series (available from Taiyo America, Inc. Carson City, NV) (good thermal characteristics for applications involving thermal control), and PROBIMER™ 8165 (good thermal characteristics for applications involving thermal control (available from Huntsman Advanced Materials Americas Inc., Los Angeles, CA); dry film soldermask, such as those in the VACREL® dry film soldermask line (available from DuPont, Wilmington, DE); film dielectrics, such as polyimide film (e.g., KAPTON® polyimide film, available from DuPont, Wilmington, DE), polyethylene, and fluoropolymers (e.g., FEP), polytetrafluoroethylene; polyester; polyethylene naphthalate; cyclo-olefin copolymer (COC); cyclo-olefin polymer (COP); any other PCB substrate material listed above; black matrix resin; polypropylene; and black flexible circuit materials, such as DuPont™ Pyralux® HXC and DuPont™ Kapton® MBC (available from DuPont, Wilmington, DE).

Droplet transport voltage and frequency may be selected for performance with reagents used in specific assay protocols. Design parameters may be varied, e.g., number and placement of on-actuator reservoirs, number of independent electrode connections, size (volume) of different reservoirs, placement of magnets/bead washing zones, electrode size, electrode shape, inter-electrode spacing, and gap height (between top and bottom substrates) may be varied for use with specific reagents, protocols, droplet volumes, etc. In some cases, a substrate of the invention may be derivatized with low surface-energy materials or chemistries, e.g., using deposition or in situ synthesis using poly- or per-fluorinated compounds in solution or polymerizable monomers. Examples include TEFLON® AF coatings and FLUOROPEL® coatings for dip or spray coating, other fluorinated monomers for plasma-enhanced chemical vapor deposition (PECVD), and organosiloxane (e.g., SiOC) for PECVD.

Additionally, in some cases, some portion or all the droplet operations surface may be coated with a substance for reducing background noise, such as background fluorescence from a PCB substrate. For example, the noise-reducing coating may include a black matrix resin, such as the black matrix resins available from Toray industries, Inc., Japan.

Electrodes of a droplet actuator are typically controlled by a controller or a processor, which is itself provided as part of a system, which may include processing functions as well as data and software storage and input and output capabilities.

Reagents may be provided on the droplet actuator in the droplet operations gap or in a reservoir liquidly coupled to the droplet operations gap. The reagents may be in liquid form, e.g., droplets, or they may be provided in a reconstitutable form in the droplet operations gap or in a reservoir liquidly coupled to the droplet operations gap. Reconstitutable reagents may typically be combined with liquids for reconstitution. An example of reconstitutable reagents suitable for use with the invention includes those described in Meathrel, et al., U.S. Pat. No. 7,727,466, entitled “Disintegratable films for diagnostic devices,” granted on Jun. 1, 2010.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets.

When such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other.

The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more).

The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode mediated.

In some cases, droplet operations are further facilitated using hydrophilic and/or hydrophobic regions on surfaces and/or by physical obstacles. For examples of droplet operations, see the patents and patent applications cited above under the definition of “droplet actuator.” Impedance and/or capacitance sensing and/or imaging techniques may sometimes be used to determine or confirm the outcome of a droplet operation. Examples of such techniques are described in Sturmer et al., International Patent Pub. No. WO/2008/101194, entitled “Capacitance Detection in a Droplet Actuator,” published on Aug. 21, 2008, the entire disclosure of which is incorporated herein by reference.

The sensing or imaging techniques may be used to confirm the presence or absence of a droplet at a specific electrode. For example, the presence of a dispensed droplet at the destination electrode following a droplet dispensing operation confirms that the droplet dispensing operation was effective. Similarly, the presence of a droplet at a detection spot at an appropriate step in an assay protocol may confirm that a previous set of droplet operations has successfully produced a droplet for detection.

Droplet transport time can be quite fast. For example, in various embodiments, transport of a droplet from one electrode to the next may be completed within about 1 sec, or about 0.1 sec, or about 0.01 sec, or about 0.001 sec. In one embodiment, the electrode is operated in AC mode but is switched to DC mode for imaging. It is helpful for conducting droplet operations for the footprint area of droplet to be like or larger than the electrowetting area; in other words, 1×-, 2×-3×-droplets are usefully controlled and/or operated using 1, 2, and 3 electrodes, respectively. If the droplet footprint is greater than number of electrodes available for conducting a droplet operation at a given time, then the difference between the droplet size and the number of electrodes should typically not be greater than 1; in other words, a 2× droplet is usefully controlled using 1 electrode and a 3× droplet is usefully controlled using 2 electrodes. When droplets include beads, it is useful for droplet size to be equal to the number of electrodes controlling the droplet, e.g., transporting the droplet.

“Filler liquid” means a liquid associated with a droplet operations substrate of a droplet actuator, which liquid is sufficiently immiscible with a droplet phase to render the droplet phase subject to electrode-mediated droplet operations. For example, the droplet operations gap of a droplet actuator is typically filled with a filler liquid. The filler liquid may, for example, be or include a low-viscosity oil, such as silicone oil or hexadecane filler liquid. The filler liquid may be or include a halogenated oil, such as a fluorinated or perfluorinated oil. The filler liquid may fill the entire gap of the droplet actuator or may coat one or more surfaces of the droplet actuator. Filler liquids may be selected to improve droplet operations and/or reduce loss of reagent or target substances from droplets, improve formation of microdroplets, reduce cross contamination between droplets, reduce contamination of droplet actuator surfaces, reduce degradation of droplet actuator materials, etc. For example, filler liquids may be selected for compatibility with droplet actuator materials.

As an example, fluorinated filler liquids may be usefully employed with fluorinated surface coatings. Fluorinated filler liquids are useful to reduce loss of lipophilic compounds, such as umbelliferone substrates like 6-hexadecanoylamido-4-methylumbelliferone substrates (e.g., for use in Krabbe, Niemann-Pick, or other assays); other umbelliferone substrates are described in U.S. Patent Pub. No. 20110118132, published on May 19, 2011, the entire disclosure of which is incorporated herein by reference. Examples of suitable fluorinated oils include those in the Galden line, such as Galden HT170 (bp=170° C., viscosity=1.8 cSt, density=1.77), Galden HT200 (bp=200C, viscosity=2.4 cSt, d=1.79), Galden HT230 (bp=230C, viscosity=4.4 cSt, d=1.82) (all from Solvay Solexis); those in the Novec line, such as Novec 7500 (bp=128C, viscosity=0.8 cSt, d=1.61), Fluorinert FC-40 (bp=155° C., viscosity=1.8 cSt, d=1.85), Fluorinert FC-43 (bp=174° C., viscosity=2.5 cSt, d=1.86) (both from 3M). In general, selection of perfluorinated filler liquids is based on kinematic viscosity (<7 cSt is preferred, but not required), and on boiling point (>150° C. is preferred, but not required, for use in DNA/RNA-based applications (PCR, etc.)). Filler liquids may, for example, be doped with surfactants or other additives.

For example, additives may be selected to improve droplet operations and/or reduce loss of reagent or target substances from droplets, formation of microdroplets, cross contamination between droplets, contamination of droplet actuator surfaces, degradation of droplet actuator materials, etc.

Composition of the filler liquid, including surfactant doping, may be selected for performance with reagents used in the specific assay protocols and effective interaction or non-interaction with droplet actuator materials. Examples of filler liquids and filler liquid formulations suitable for use with the invention are provided in Srinivasan et al, International Patent Pub. Nos. WO/2010/027894, entitled “Droplet Actuators, Modified Liquids and Methods,” published on Mar. 11, 2010, and WO/2009/021173, entitled “Use of Additives for Enhancing Droplet Operations,” published on Feb. 12, 2009; Sista et al., International Patent Pub. No. WO/2008/098236, entitled “Droplet Actuator Devices and Methods Employing Magnetic Beads,” published on Aug. 14, 2008; and Monroe et al., U.S. Patent Publication No. 20080283414, entitled “Electrowetting Devices,” filed on May 17, 2007; the entire disclosures of which are incorporated herein by reference, as well as the other patents and patent applications cited herein. Fluorinated oils may in some cases be doped with fluorinated surfactants, e.g., Zonyl FSO-100 (Sigma-Aldrich) and/or others.

“Reservoir” means an enclosure or partial enclosure configured for holding, storing, or supplying liquid. A droplet actuator system of the invention may include on-cartridge reservoirs and/or off-cartridge reservoirs. On-cartridge reservoirs may be (1) on-actuator reservoirs, which are reservoirs in the droplet operations gap or on the droplet operations surface; (2) off-actuator reservoirs, which are reservoirs on the droplet actuator cartridge, but outside the droplet operations gap, and not in contact with the droplet operations surface; or (3) hybrid reservoirs which have on-actuator regions and off-actuator regions.

An example of an off-actuator reservoir is a reservoir in the top substrate. An off-actuator reservoir is typically in liquid communication with an opening or flow path arranged for flowing liquid from the off-actuator reservoir into the droplet operations gap, such as into an on-actuator reservoir. An off-cartridge reservoir may be a reservoir that is not part of the droplet actuator cartridge at all, but which flows liquid to some portion of the droplet actuator cartridge. For example, an off-cartridge reservoir may be part of a system or docking station to which the droplet actuator cartridge is coupled during operation. Similarly, an off-cartridge reservoir may be a reagent storage container or syringe which is used to force liquid into an on-cartridge reservoir or into a droplet operations gap. A system using an off-cartridge reservoir will typically include a liquid passage means whereby liquid may be transferred from the off-cartridge reservoir into an on-cartridge reservoir or into a droplet operations gap.

“Washing” with respect to washing a surface, such as a hydrophilic surface, means reducing the amount and/or concentration of one or more substances in contact with the surface or exposed to the surface from a droplet in contact with the surface. The reduction in the amount and/or concentration of the substance may be partial, substantially complete, or even complete. The substance may be any of a wide variety of substances; examples include target substances for further analysis, and unwanted substances, such as components of a sample, contaminants, and/or excess reagent or buffer.

The terms “top,” “bottom,” “over,” “under,” and “on” are used throughout the description with reference to the relative positions of components of the droplet actuator, such as relative positions of top and bottom substrates of the droplet actuator. It will be appreciated that in many cases the droplet actuator is functional regardless of its orientation in space.

When a liquid in any form (e.g., a droplet or a continuous body, whether moving or stationary) is described as “on”, “at”, or “over” an electrode, array, matrix or surface, such liquid could be either in direct contact with the electrode/array/matrix/surface or could be in contact with one or more layers or films that are interposed between the liquid and the electrode/array/matrix/surface. In one example, filler liquid can be considered as a dynamic film between such liquid and the electrode/array/matrix/surface.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

The subject matter now will be described more fully hereinafter with reference to the accompanying drawings, in which some, but not all embodiments of the subject matter are shown. Like numbers refer to like elements throughout. The subject matter may be embodied in many different forms and should not be construed as limited to the embodiments set forth herein; rather, these embodiments are provided so that this disclosure will satisfy applicable legal requirements. Many modifications and other embodiments of the subject matter set forth herein will come to mind to one skilled in the art to which the subject matter pertains having the benefit of the teachings presented in the foregoing descriptions and the associated Drawings. Therefore, it is to be understood that the subject matter is not to be limited to the specific embodiments disclosed and that modifications and other embodiments are intended to be included within the scope of the appended claims.

### 1.2. Introduction

The disclosure provides a digital microfluidics (DMF) devices and methods for dispensing liquids using piercer features and compressible membranes.

The DMF device may include an arrangement of piercer features embedded in a compressible membrane layer that may be used as the actuation mechanism for dispensing liquids therein.

The DMF device may include a DMF portion and a well-plate portion and wherein the well-plate portion may include a needle feature embedded in a compressible membrane and positioned with respect to a liquid well and wherein the needle feature may be used to both pierce through the compressible membrane and to dispense liquid into the DMF portion.

The DMF device may include a DMF portion and a well-plate portion and wherein the well-plate portion may include a needle feature embedded in a compressible membrane and positioned with respect to a liquid well and a process of compressing together the well-plate portion and the DMF portion by which needle feature may pierce through the compressible membrane and dispense liquid into the DMF portion.

The DMF device may include a DMF portion and a well-plate portion and wherein the DMF portion includes piercer features embedded in a compressible membrane and positioned with respect to a liquid well in the well-plate portion and wherein the piercer features may be used to pierce through the compressible membrane and release liquid from the liquid well in the well-plate portion into the DMF portion.

The DMF device may include a DMF portion and a well-plate portion and wherein the DMF portion includes piercer features embedded in a compressible membrane and positioned with respect to a liquid well in the well-plate portion and a process of compressing together the well-plate portion and the DMF portion by which the piercer features may pierce through the compressible membrane and release liquid from the liquid well in the well-plate portion into the DMF portion.

The DMF device may include a DMF portion and a well-plate portion that are separatable and wherein membrane layers may be used to provide the connection/disconnection mechanism therebetween.

The DMF device may include a DMF portion and a well-plate portion that are separatable and wherein the DMF portion includes piercer features embedded in a compressible membrane and positioned with respect to at least two liquid wells in the well-plate portion for dispensing liquid into the DMF portion using a two-stage actuation process.

The DMF device may include DMF piercer features embedded in a compressible membrane and wherein the compressible membrane may be used for aspirating liquid instead of dispensing liquid.

### 1.3. Well Plate Piercer

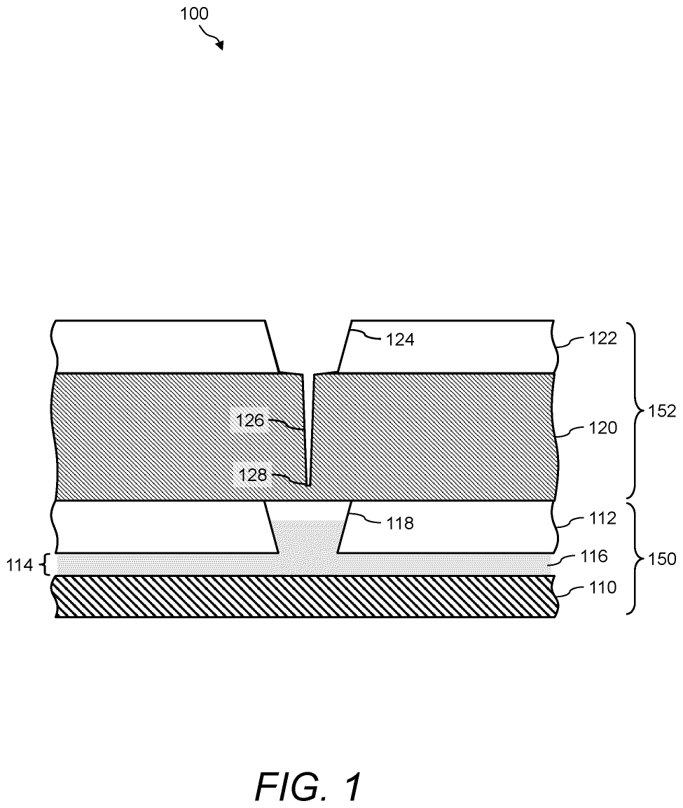

FIG. 1 through FIG. 5 show side views of an example of a DMF device 100 including well-plate piercer features embedded in a compressible membrane and a process of using the same. Referring now to FIG. 1, DMF device 100 may include, for example, a bottom substrate 110 and a top substrate 112 separated by a droplet operations gap 114 that forms a chamber in which droplet operations may be performed. Further, droplet operations gap 114 of DMF device 100 may be filled with a filler liquid 116. Filler liquid 116 may, for example, be or include a low-viscosity oil, such as silicone oil or hexadecane filler liquid. Bottom substrate 110 may be, for example, a glass substrate or a printed circuit board (PCB)-based substrate that includes an arrangement of droplet operations electrodes (e.g., electrowetting electrodes, not shown). Top substrate 112 may be formed, for example, of plastic or glass. Further, top substrate 112 may include a loading port 118 for loading liquid (e.g., sample liquid, reagents) into droplet operations gap 114.

Additionally, a membrane layer 120 may be provided atop top substrate 112 and a well plate 122 may be provided atop membrane layer 120. Adhesive on both sides of membrane layer 120 may be used to bond membrane layer 120 to top substrate 112 on one side and to well plate 122 on the other side. In another example, membrane layer 120 may be placed without bonding. In yet another example, membrane layer 120 may be molded in-place during the manufacturing of, for example, top substrate 112. Well plate 122 may include a liquid well (or reservoir) 124 that substantially aligns with loading port 118 in top substrate 112. Liquid well 124 may hold, for example, from about 1 uL to about 10 mL of liquid. Further, a hollow needle feature 126 may be provided at the outlet of liquid well 124. Further, there is an opening 128 at the distal tip of needle feature 126. The thickness of membrane layer 120 is set such that needle feature 126 of liquid well 124 is embedded fully in membrane layer 120 when membrane layer 120 is in an uncompressed or relaxed state. At the same time, the thickness of membrane layer 120 is set such that needle feature 126 of liquid well 124 may punch through membrane layer 120 when membrane layer 120 is in a compressed state. In one example, needle feature 126 may be from about 0.9 mm to about 20 mm long. In this example, membrane layer 120 may be from about 1 mm to about 25 mm thick when uncompressed and from about 0.7 mm to about 19 mm thick when compressed.

The characteristics of membrane layer 120 are such that it may provide an air and moisture-tight seal against opening 128 of needle feature 126 when membrane layer 120 is in the uncompressed or relaxed state. Membrane layer 120 may be formed, for example, of rubber or elastomer compounds, such as, but not limited to, natural rubber compounds, silicone rubber compounds, butyl rubber compounds, ethylene propylene diene monomer (EPDM) rubber compounds, nitrile rubber compounds, polychloroprene (e.g., Neoprene®) rubber compounds, fluorocarbon (e.g., Viton®) rubber compounds, tetrafluoroethylene/propylene (TPE/P) rubber compounds, and the like.

In DMF device 100, bottom substrate 110 and top substrate 112 with droplet operations gap 114 therebetween may form a DMF portion 150 of DMF device 100. Further, membrane layer 120 and well plate 122 may form a well-plate portion 152 of DMF device 100. Needle feature 126 protruding downward from liquid well 124 in well plate 122 is one example of a well-plate piercer feature. More specifically, needle feature 126 protrudes downward from well-plate portion 152 and toward DMF portion 150 of DMF device 100.

Further, in DMF device 100, DMF portion 150 is not limited to one loading port 118 only and well-plate portion 152 is not limited to one liquid well 124 only. DMF device 100 may include any number and/or arrangements of loading ports 118 and corresponding liquid wells 124.

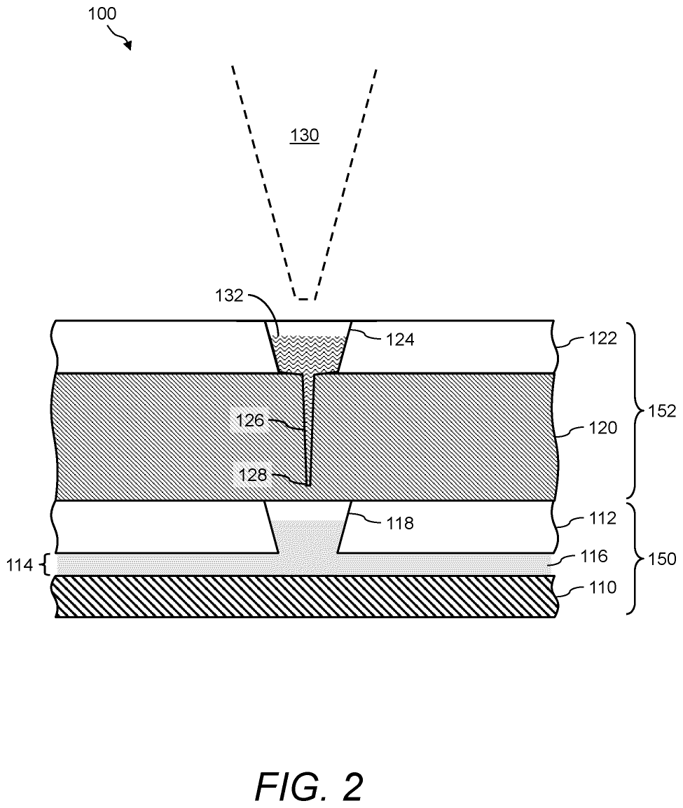

Referring now to FIG. 2 through FIG. 5 is a process of dispensing liquid using the DMF device 100 shown in FIG. 1. In one example, FIG. 2 shows that well-plate portion 152 may be provided preloaded with liquid 132. That is, liquid well 124 of well plate 122 may be preloaded with liquid 132 and sealed. In another example, at runtime a pipette 130 may be used to fill liquid well 124 with some volume of liquid 132. Liquid 132 may be any liquid to be processed in DMF device 100, such as, but not limited to, sample liquid, reagents, buffer solution, and the like. Further, needle feature 126 of liquid well 124 fills with liquid 132. However, liquid 132 is held sealed inside needle feature 126 by the uncompressed membrane layer 120 which is providing a substantially air and moisture-tight seal against opening 128 of needle feature 126. Further, the uncompressed membrane layer 120 keeps filler liquid 116 sealed within DMF portion 150 of DMF device 100. Accordingly, the uncompressed membrane layer 120 may be used to seal liquids within both DMF portion 150 and well-plate portion 152 of DMF device 100.

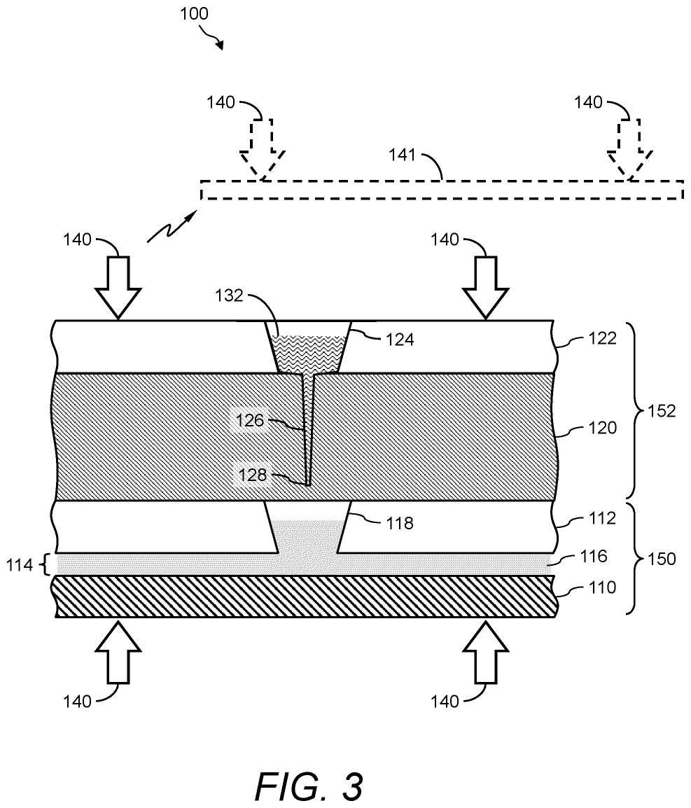

Next, FIG. 3 shows DMF portion 150 and well-plate portion 152 brought together and with membrane layer 120 still in the uncompressed state. However, certain compression forces 140 may be applied to begin compressing membrane layer 120.

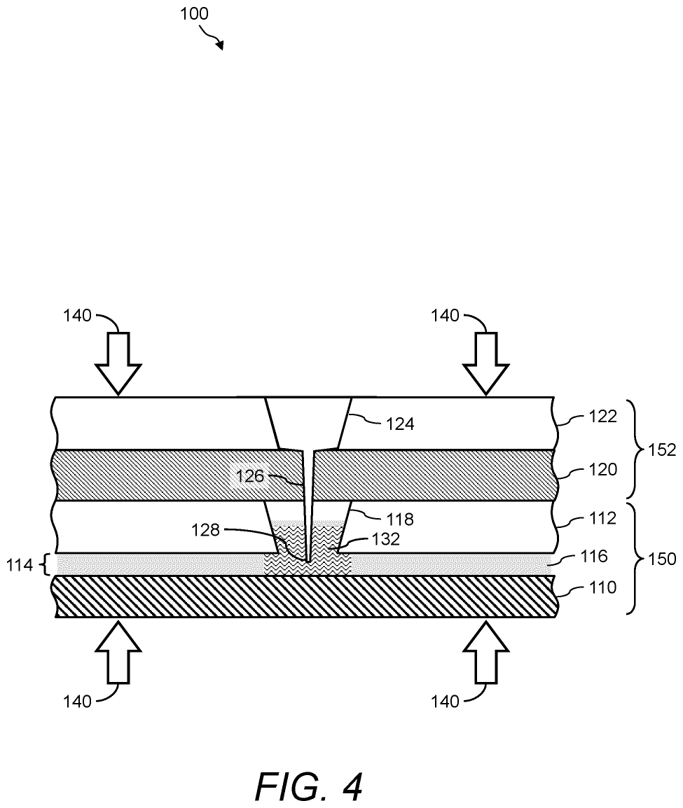

As described herein, to apply compression forces 140 to any DMF device may mean, for example, that (1) DMF portion 150 may be held stationary while compression forces 140 may be applied to well-plate portion 152; (2) well-plate portion 152 may be held stationary while compression forces 140 may be applied to DMF portion 150; and/or (3) opposite compression forces 140 may be applied to both DMF portion 150 and well-plate portion 152 at substantially the same time. The purpose of applying compression forces 140 to any DMF device that is described herein may be to compress one or more membrane layers, such as membrane layer 120 shown in FIG. 4. In one example, compression forces 140 may be applied via a pressure plate or membrane 141 (see FIG. 3) that may be pressed against the outer surface of DMF portion 150 and/or well-plate portion 152.

Next, FIG. 4 shows compression forces 140 being applied to DMF portion 150 and/or well-plate portion 152 of DMF device 100. In so doing, membrane layer 120 may be compressed. In the process of compressing membrane layer 120, needle feature 126 pierces through membrane layer 120. At the point in which the compressed thickness of membrane layer 120 is less than the length of needle feature 126, then opening 128 of needle feature 126 enters loading port 118 of top substrate 112 in an unsealed fashion and liquid 132 may be released from liquid well 124 of well plate 122. That is, by punching through membrane layer 120, needle feature 126 becomes unsealed and provides a liquid path between liquid well 124 of well plate 122 and loading port 118 of top substrate 112. As a result, liquid 132 may be dispensed into the droplet operations gap 114 of DMF portion 150, as shown here in FIG. 4.

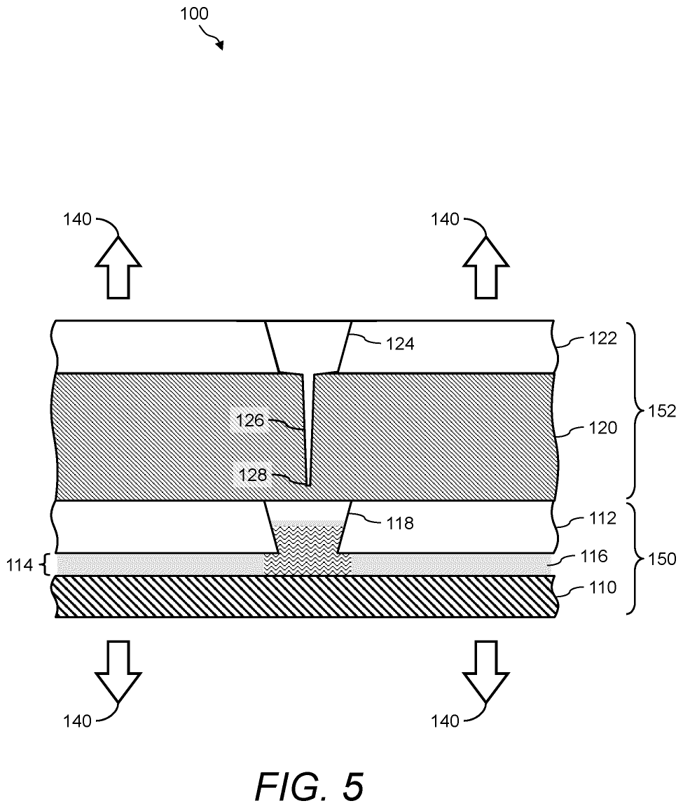

Next, upon completion of the liquid dispensing operation, FIG. 5 shows that compression forces 140 may be released from DMF portion 150 and/or well-plate portion 152 of DMF device 100. In so doing, membrane layer 120 may return to its relaxed or uncompressed state and needle feature 126 is now again embedded and sealed within membrane layer 120. Liquid well 124 of well plate 122 is now substantially empty of liquid 132. Liquid 132 is now in droplet operations gap 114 of DMF portion 150 and ready to be processed. Further, the relaxed membrane layer 120 retains all liquids and oil within DMF portion 150. In this example, after dispensing liquid 132, the uncompressed membrane layer 120 may provide a substantially airtight seal to the entirety of or to select regions of DMF portion 150 of DMF device 100.

Referring now again to FIG. 4 and FIG. 5, in another example, instead of releasing the compression forces 140 as shown in FIG. 5, a certain amount of compression forces 140 may be maintained such that membrane layer 120 is held in compression as shown in FIG. 4. In this example, any plate or membrane 141 used to apply compression forces 140 (see FIG. 3) may be used to provide an airtight seal of DMF portion 150 and/or well-plate portion 152 of DMF device 100. This example may require that the plate or membrane 141 of compression forces 140 be formed of and/or coated with, for example, some type of rubber or elastomer material.

### 1.4. Two-Piece Well Plate Piercer

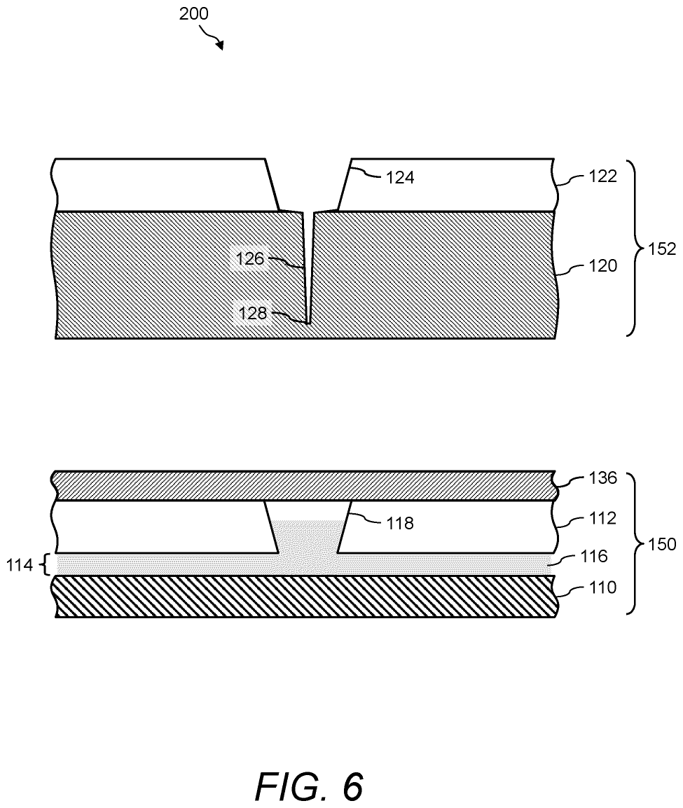

In another example, FIG. 6 through FIG. 11 show side views of an example of a two-piece DMF device 200 including well-plate piercer features embedded in a compressible membrane and a process of using the same. Two-piece DMF device 200 may be substantially the same as DMF device 100 of FIG. 1 through FIG. 5 except that well-plate portion 152 that includes membrane layer 120 and well plate 122 that further includes liquid well 124 with needle feature 126 may be formed and provided separately from DMF portion 150. Likewise, DMF portion 150 may be formed and provided separately from well-plate portion 152. To do this, DMF portion 150 may include an additional membrane layer 136 atop top substrate 112. In this example, membrane layer 136 provides a seal for the separately provided DMF portion 150. Likewise, membrane layer 120 provides a seal for the separately provided well-plate portion 152.

In two-piece DMF device 200, DMF portion 150 and well-plate portion 152 may be formed separately and then mated together. For example, membrane layer 136 on DMF portion 150 and membrane layer 120 on well-plate portion 152 provide a connection/disconnection mechanism. A benefit of two-piece DMF device 200 is that DMF portion 150 and well-plate portion 152 may be stored separately (e.g., well-plate portion 152 holding liquid 132 may be refrigerated).

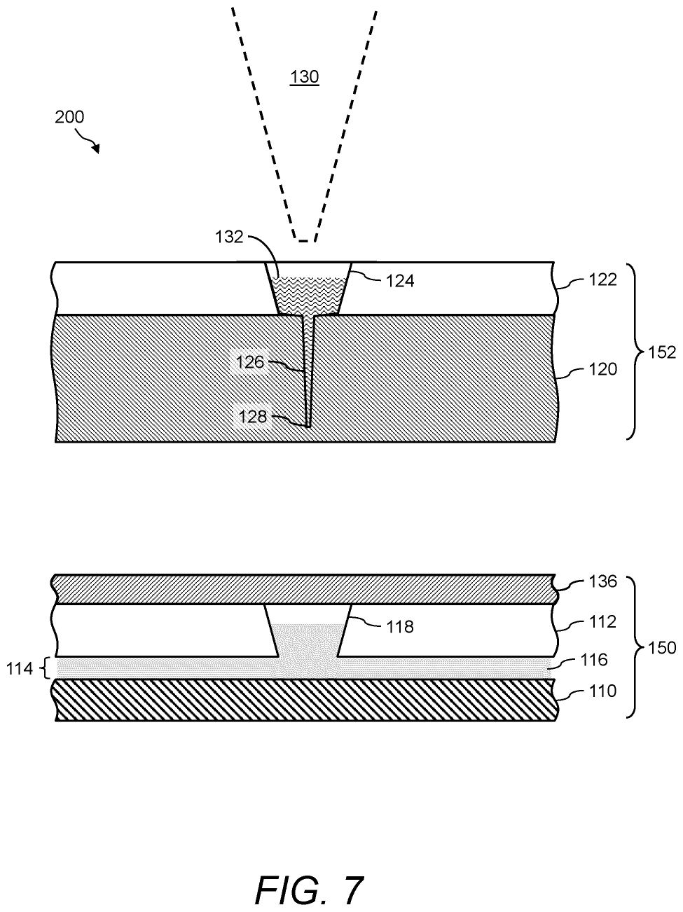

FIG. 7 through FIG. 11 show an example of using two-piece DMF device 200. For example, FIG. 7 shows liquid well 124 of the separate well-plate portion 152 being filled with liquid 132.

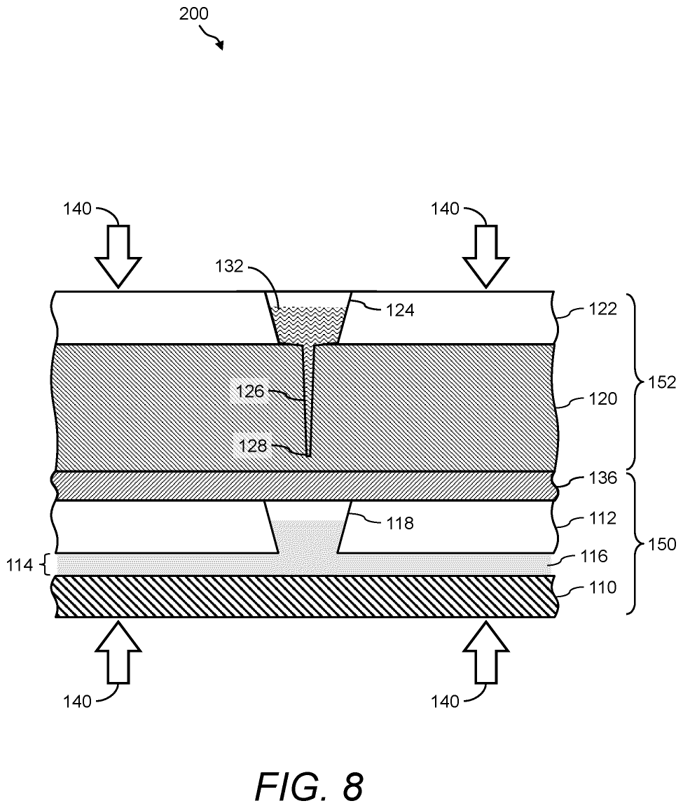

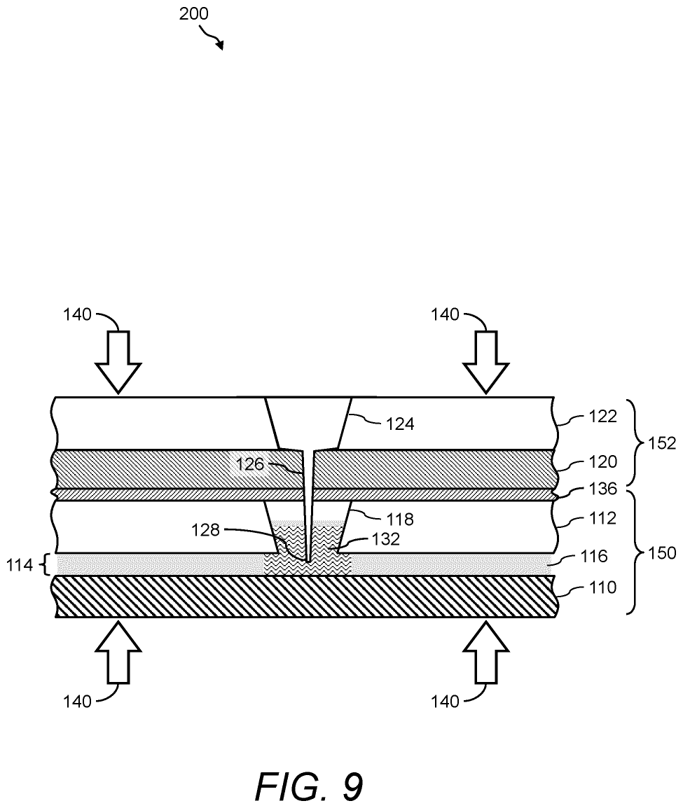

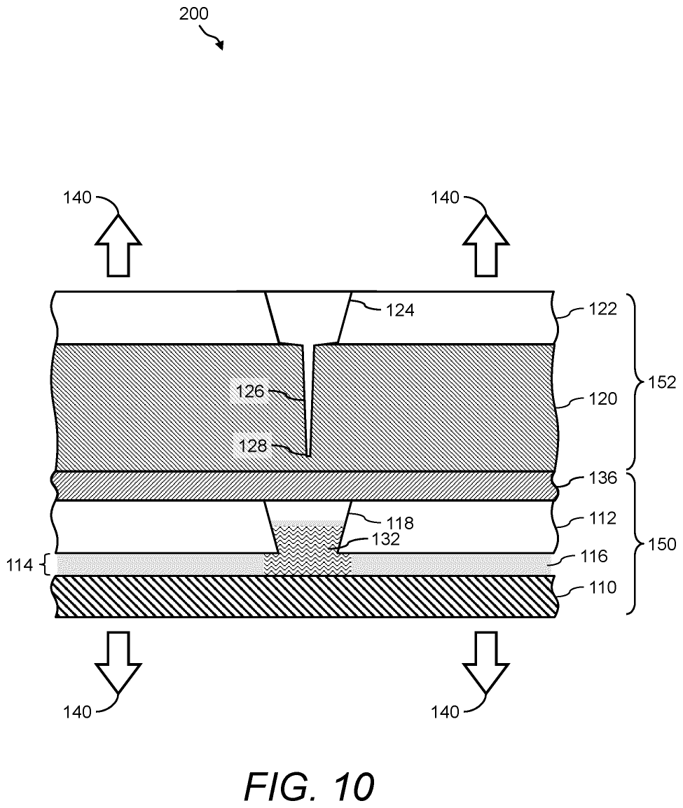

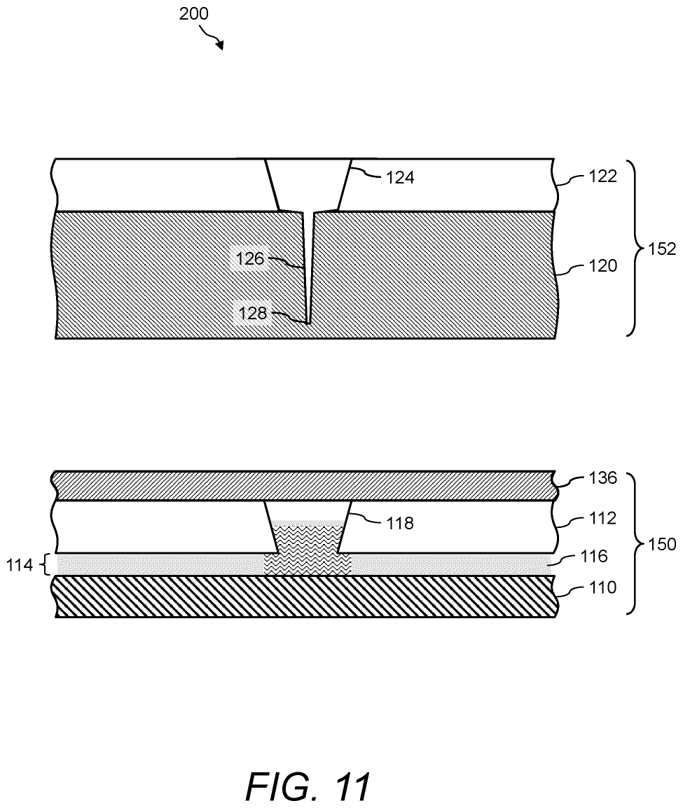

Next, FIG. 8 shows DMF portion 150 and well-plate portion 152 mated together with membrane layer 136 of DMF portion 150 against membrane layer 120 of well-plate portion 152. Also, FIG. 8 shows compression forces 140 being applied to DMF portion 150 and/or well-plate portion 152 of DMF device 200. From here and referring now to FIG. 9, FIG. 10, and FIG. 11, two-piece DMF device 200 operates substantially the same as DMF device 100 shown in FIG. 1 through FIG. 5. A difference being that two membrane layers (i.e., membrane layers 120, 136) are compressed instead of just one membrane layer 120. Again, optionally, after the dispensing operation is complete, membrane layer 120 may be held in a compressed state rather than compression forces 140 being entirely released.

Referring now again to DMF device 100 shown in FIG. 1 through FIG. 5 and two-piece DMF device 200 shown in FIG. 6 through FIG. 11, DMF device 100 and/or two-piece DMF device 200 may be pre-filled with filler liquid 116 without fear of leaking (as membrane layers 120, 136 seal the interfaces). Further, DMF device 100 and/or two-piece DMF device 200 provide the benefit of containing filler liquid 116 within the device, reducing oil spill chances, and simplifying waste disposal. Furthermore, the user has the advantage of filling a simple well-plate style top-layer that is familiar to them as opposed to following pipetting instructions specific to the DMF device with oil medium

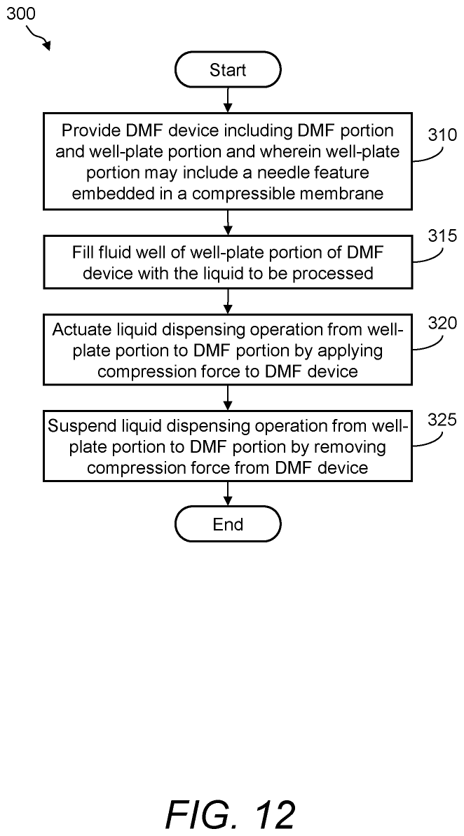

Referring now to FIG. 12 is a flow diagram of an example of a method 300 of dispensing liquid using the DMF devices 100, 200 shown in FIG. 1 through FIG. 11. Method 300 may include, but is not limited to, the following steps.

At a step 310, a DMF device is provided that may include a DMF portion and a well-plate portion and wherein the well-plate portion may include a needle feature embedded in a compressible membrane. In one example, the DMF device 100 shown in FIG. 1 through FIG. 5 is provided that may include DMF portion 150 and well-plate portion 152 and wherein well-plate portion 152 may include needle feature 126 embedded in membrane layer 120 and positioned at the outlet of liquid well 124 and wherein needle feature 126 may be used to both pierce through membrane layer 120 and to dispense liquid 132 into DMF portion 150. In another example, the two-piece DMF device 200 shown in FIG. 6 through FIG. 11 is provided that may include DMF portion 150 and well-plate portion 152, which may be provided separately and then mated together when in use.

At a step 315, a liquid well of the well-plate portion of the DMF device is filled with the liquid to be processed. For example, in either DMF device 100 shown in FIG. 1 through FIG. 5 or two-piece DMF device 200 shown in FIG. 6 through FIG. 11, liquid well 124 of well plate 122 of well-plate portion 152 is filled with any type of liquid 132 to be processed, such as sample liquid, reagents, buffer solution, and the like. For example, FIG. 2 and FIG. 7 show pipette 130 being used to fill liquid well 124 with liquid 132.

At a step 320, a liquid dispensing operation from the well-plate portion to the DMF portion is actuated by applying compression force to the DMF device. For example, a liquid dispensing operation is actuated by applying compression force to either DMF device 100 shown in FIG. 1 through FIG. 5 or two-piece DMF device 200 shown in FIG. 6 through FIG. 11. In so doing, membrane layer 120 (and 136) may be compressed to release liquid 132 from needle feature 126 of well-plate portion 152 into loading port 118 of DMF portion 150. For example, FIG. 3 and FIG. 4 as well as FIG. 8 and FIG. 9 show an example of a process of using compression forces 140 to dispense liquid 132 from well-plate portion 152 into DMF portion 150. By applying the compression forces 140 to DMF portion 150 and/or well-plate portion 152 of DMF device 100 or two-piece DMF device 200, needle feature 126 punches through the compressed membrane layer 120 (and 136) and being now unsealed can release liquid 132 into loading port 118.

At a step 325, the liquid dispensing operation from the well-plate portion to the DMF portion is suspended by removing the compression force from the DMF device. For example, the liquid dispensing operation is suspended by removing the compression force from either DMF device 100 shown in FIG. 1 through FIG. 5 or two-piece DMF device 200 shown in FIG. 6 through FIG. 11. For example, FIG. 5 and FIG. 6 as well as FIG. 10 and FIG. 11 show an example of a process of removing the compression forces 140 and thereby suspending the liquid dispensing operation from well-plate portion 152 into DMF portion 150. By removing the compression force, membrane layer 120 relaxes and needle feature 126 is withdrawn back into the relaxed membrane layer 120 and needle feature 126 is again sealed. Further, the relaxed membrane layer 120 retains all liquids and oil within DMF portion 150.

Referring now again to FIG. 1 through FIG. 12, the DMF device 100, two-piece DMF device 200, and method 300 may be an example of an arrangement of piercer features (e.g., needle feature 126) embedded in a compressible membrane layer (e.g., membrane layer 120) that may be used as the actuation mechanism for dispensing liquids therein.

### 1.5. DMF Piercer with Blister Pack

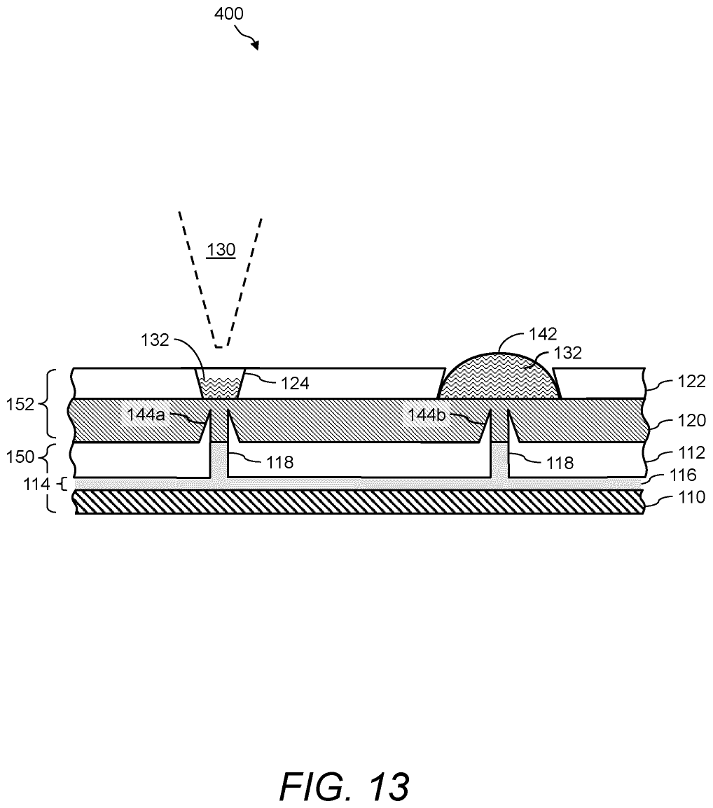

FIG. 13 through FIG. 16 show side views of an example of a DMF device 400 including DMF piercer features embedded in a compressible membrane and a process of using the same. Referring now to FIG. 13, like DMF device 100 shown in FIG. 1 through FIG. 5, DMF device 400 may include bottom substrate 110 and top substrate 112 separated by droplet operations gap 114, membrane layer 120 atop top substrate 112, and well plate 122 atop membrane layer 120. Accordingly, like DMF device 100, DMF device 400 may include DMF portion 150 and well-plate portion 152.

However, different from DMF device 100, DMF device 400 is absent needle feature 126 at the outlet of liquid well 124. In this example, well plate 122 of DMF device 400 may include at least one liquid well 124 and at least one blister pack 142. Blister pack 142 may be, for example, an off-the-shelf blister pack for holding pre-made reagents. Generally, blister packs include a foil and/or cellophane seal that may be broken or pierced to release the liquid therein. In this example, the breakable seal (not shown) of blister pack 142 faces membrane layer 120.

Additionally, in this example, top substrate 112 may include two loading ports 118. One loading port 118 for receiving liquid from liquid well 124 of well plate 122 and another loading port 118 for receiving liquid from blister pack 142 of well plate 122. Further, DMF device 400 may include certain piercer features 144 extending from each of the loading ports 118 into membrane layer 120 and toward well plate 122. For example, piercer features 144a may be directed toward liquid well 124 and piercer features 144b may be directed toward blister pack 142.

When membrane layer 120 is in the relaxed or uncompressed state, piercer features 144a and 144b are substantially embedded within membrane layer 120. In this state, membrane layer 120 seals shut the liquid path that is present through piercer features 144a and 144b to loading ports 118 that supply droplet operations gap 114. By contrast, when membrane layer 120 is in the compressed state, piercer features 144a and 144b may punch through the compressed membrane layer 120 and open up liquid paths from liquid well 124 and blister pack 142 to loading ports 118. Further, piercer features 144b may be used to pierce or rupture blister pack 142.

In this example, the thickness of membrane layer 120 is set such that piercer features 144 of top substrate 112 may be embedded fully in membrane layer 120 when membrane layer 120 is in an uncompressed or relaxed state. At the same time, the thickness of membrane layer 120 is set such that piercer features 144 of top substrate 112 may punch through membrane layer 120 when membrane layer 120 is in a compressed state. In one example, piercer features 144 may be from about 0.9 mm to about 20 mm long. In this example, membrane layer 120 may be from about 1.1 mm to about 25 mm thick when uncompressed and from about 0.7 mm to about 19 mm thick when compressed.

Further, in DMF device 400, well-plate portion 152 is not limited to one liquid well 124 only and one blister pack 142 only. DMF device 400 may include any number and/or arrangements of liquid wells 124 and blister packs 142 and corresponding loading ports 118. In one example, DMF device 400 may be provided preloaded with liquid 132. In another example, at runtime a pipette 130 may be used to fill liquid well 124 with some volume of liquid 132.

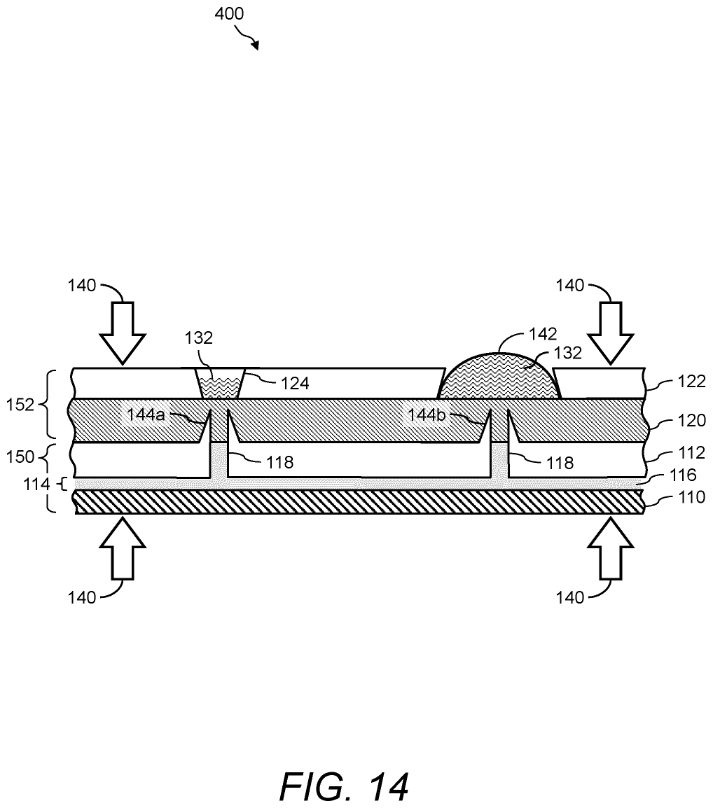

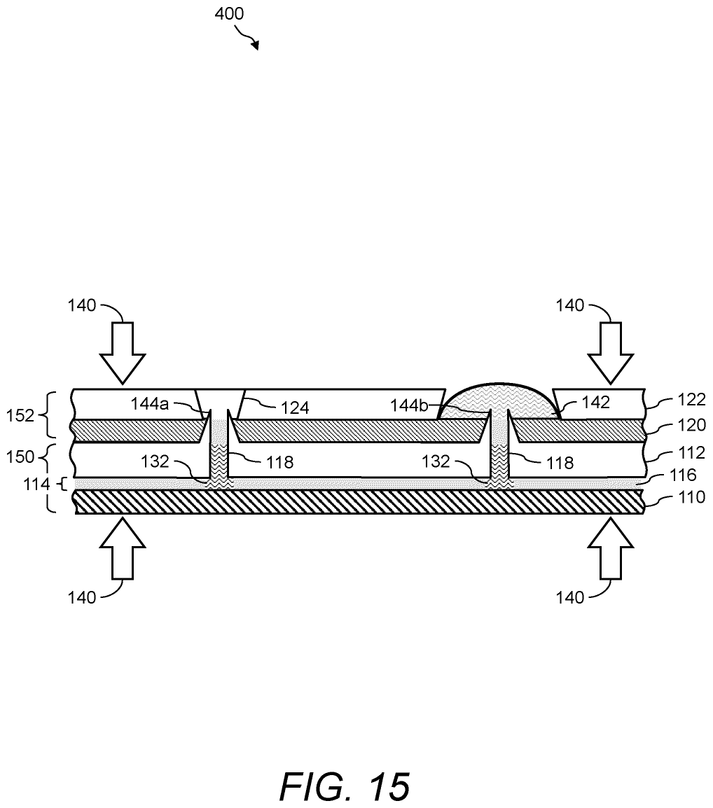

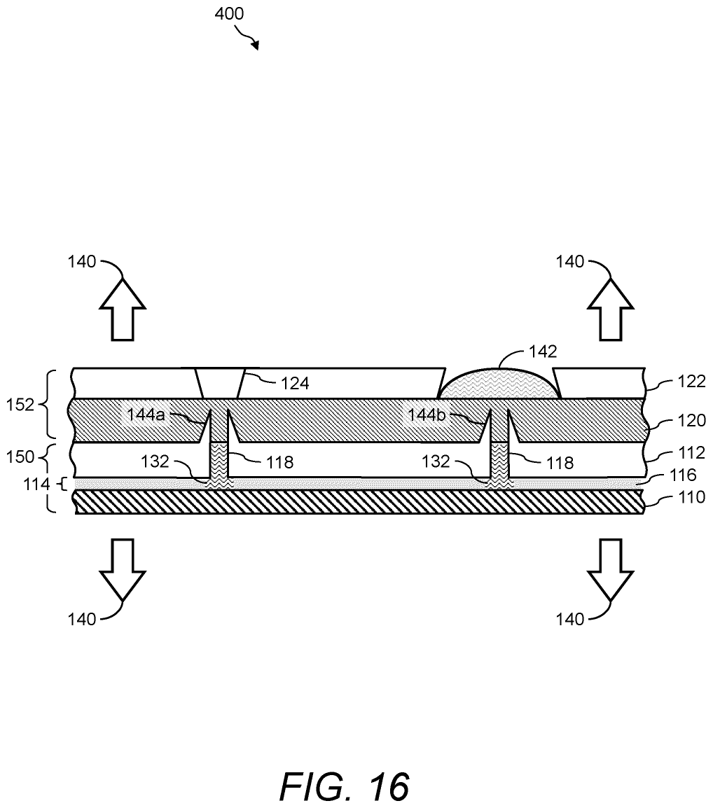

Referring now to FIG. 14, FIG. 15, and FIG. 16 is a process of dispensing liquid using the DMF device 400 shown in FIG. 13. For example, FIG. 14 shows compression forces 140 may be applied to DMF portion 150 and/or well-plate portion 152 of DMF device 400.

Next, FIG. 15 shows yet more compression forces 140 being applied to DMF portion 150 and/or well-plate portion 152 of DMF device 400. In so doing, membrane layer 120 may be compressed. In the process of compressing membrane layer 120, piercer features 144a and 144b pierce through membrane layer 120. At the point in which the compressed thickness of membrane layer 120 is less than the length of piercer features 144a and 144b, then piercer features 144a and 144b may punch through the compressed membrane layer 120 and enter liquid well 124 and rupture blister pack 142, respectively. In this way, a liquid path is provided from liquid well 124 and blister pack 142 to the corresponding loading ports 118. At a result, liquid 132 may be dispensed from liquid well 124 and blister pack 142 into the droplet operations gap 114 of DMF portion 150, as shown here in FIG. 15.

Next, upon completion of the liquid dispensing operation, FIG. 16 shows that compression forces 140 may be released from DMF portion 150 and/or well-plate portion 152 of DMF device 400. In so doing, membrane layer 120 may return to its relaxed or uncompressed state and piercer features 144a and 144b are now again embedded and sealed within membrane layer 120. Liquid 132 is now in droplet operations gap 114 of DMF portion 150 and ready to be processed. Further, the relaxed membrane layer 120 retains all liquids and oil within DMF portion 150.

### 1.6. Two-Piece DMF Piercer with Blister Pack

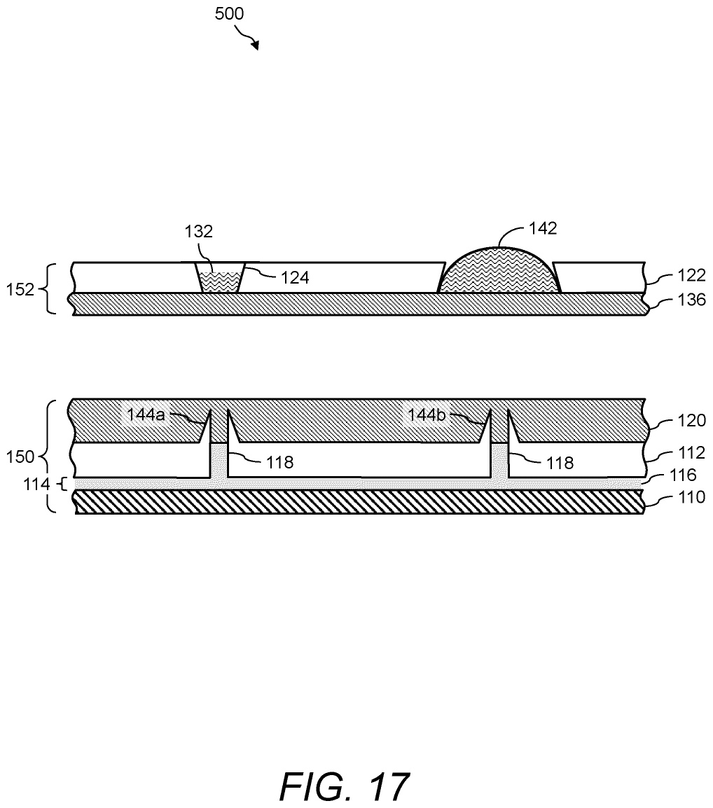

In another example, FIG. 17 through FIG. 19 show side views of an example of a two-piece DMF device 500 including DMF piercer features embedded in a compressible membrane and a process of using the same. Two-piece DMF device 500 may be substantially the same as DMF device 400 of FIG. 13 through FIG. 16 except that well-plate portion 152 includes a membrane layer 136 on well plate 122 and may be formed and provided separately from DMF portion 150. Likewise, DMF portion 150 may be formed and provided separately from well-plate portion 152. In this example, membrane layer 120 provides a seal for the separately provided DMF portion 150. Likewise, membrane layer 136 provides a seal for the separately provided well-plate portion 152.

In two-piece DMF device 500, DMF portion 150 and well-plate portion 152 may be formed separately and then mated together. For example, membrane layer 120 on DMF portion 150 and membrane layer 136 on well-plate portion 152 provide a connection/disconnection mechanism. A benefit of two-piece DMF device 500 is that DMF portion 150 and well-plate portion 152 may be stored separately (e.g., well-plate portion 152 holding liquid 132 may be refrigerated).

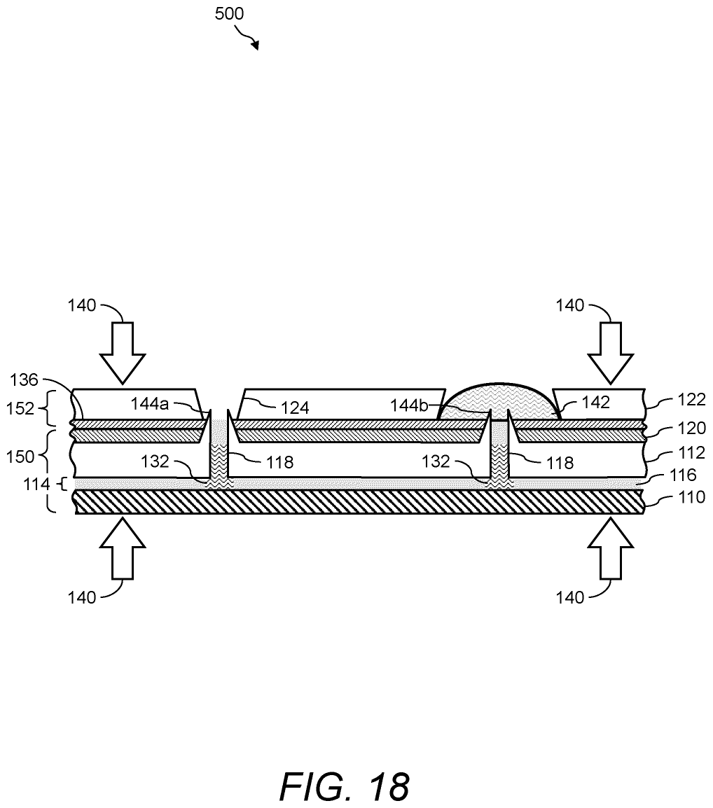

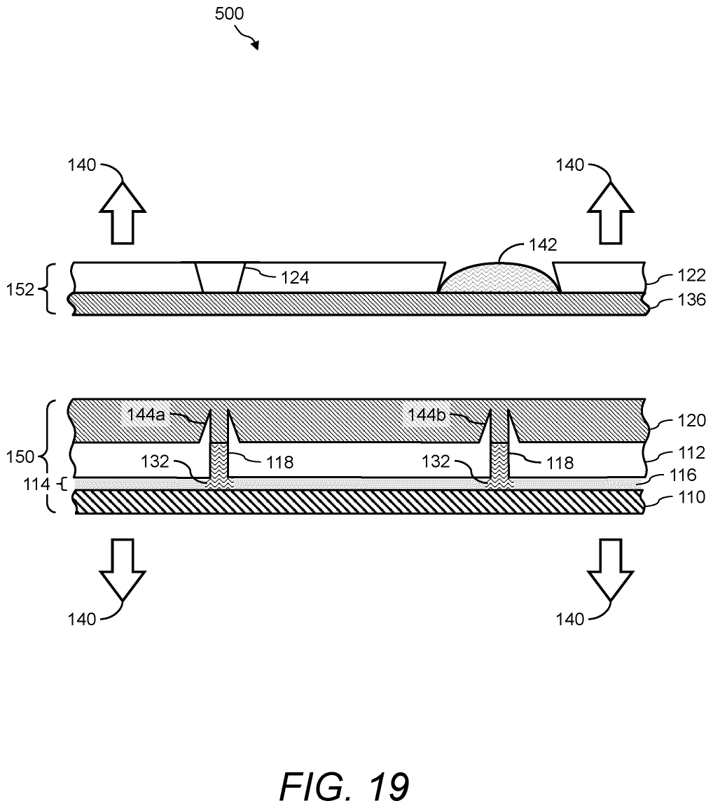

FIG. 18 and FIG. 19 show an example of using two-piece DMF device 500. For example, FIG. 18 shows DMF portion 150 and well-plate portion 152 mated together with membrane layer 120 of DMF portion 150 against membrane layer 136 of well-plate portion 152. Further, FIG. 18 shows compression forces 140 may be applied to DMF portion 150 and/or well-plate portion 152 of two-piece DMF device 500. In so doing, both membrane layers 120 and 136 may be compressed and liquid 132 may be dispensed as described with reference to DMF device 400 in FIG. 15. Next, upon completion of the liquid dispensing operation, FIG. 19 shows that compression forces 140 may be released from DMF portion 150 and/or well-plate portion 152 of two-piece DMF device 500 as described with respect to DMF device 400 in FIG. 16.

Referring now again to DMF device 400 shown in FIG. 13 through FIG. 16 and two-piece DMF device 500 shown in FIG. 17 through FIG. 19, DMF device 400 and/or two-piece DMF device 500 may be pre-filled with filler liquid 116 without fear of leaking (as membrane layers 120, 136 seal the interfaces). Further, DMF device 400 and/or two-piece DMF device 500 provide the benefit of containing filler liquid 116 within the device, reducing oil spill chances, and simplifying waste disposal.

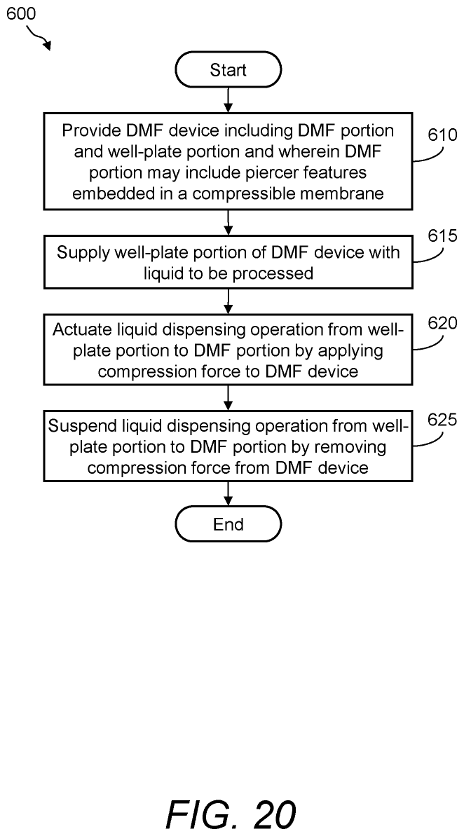

Referring now to FIG. 20 is a flow diagram of an example of a method 600 of dispensing liquid using the DMF devices 400, 500 shown in FIG. 13 through FIG. 19. Method 600 may include, but is not limited to, the following steps.

At a step 610, a DMF device is provided that may include a DMF portion and a well-plate portion and wherein the DMF portion may include piercer features embedded in a compressible membrane. In one example, the DMF device 400 shown in FIG. 13 through FIG. 16 is provided that may include DMF portion 150 and well-plate portion 152 and wherein DMF portion 150 may include piercer features 144 at loading ports 118 and embedded in membrane layer 120 and wherein piercer features 144 may be used to both pierce through membrane layer 120 and to provide a flow path between liquid well 124 and/or blister pack 142 of well-plate portion 152 and DMF portion 150. In another example, the two-piece DMF device 500 shown in FIG. 17 through FIG. 19 is provided that may include DMF portion 150 and well-plate portion 152, which may be provided separately and then mated together when in use.

At a step 615, the well-plate portion of the DMF device is supplied with liquid to be processed. For example, in either DMF device 400 shown in FIG. 13 through FIG. 16 or two-piece DMF device 500 shown in FIG. 17 through FIG. 19, liquid well 124 of well plate 122 of well-plate portion 152 is filled with any type of liquid 132 to be processed, such as sample liquid, reagents, buffer solution, and the like. Further, a blister pack 142 may be installed in well plate 122. For example, FIG. 13 shows pipette 130 being used to fill liquid well 124 with liquid 132. FIG. 13 also shows blister pack 142.

At a step 620, a liquid dispensing operation from the well-plate portion to the DMF portion is actuated by applying compression force to the DMF device. For example, a liquid dispensing operation is actuated by applying compression force to either DMF device 400 shown in FIG. 13 through FIG. 16 or two-piece DMF device 500 shown in FIG. 17 through FIG. 19. In so doing, membrane layer 120 (and 136) may be compressed to release liquid 132 from liquid well 124 and/or blister pack 142 of well plate 122 of well-plate portion 152 into loading ports 118 of DMF portion 150. For example, FIG. 14 and FIG. 15 as well as FIG. 18 show an example of a process of using compression forces 140 to dispense liquid 132 from well-plate portion 152 into DMF portion 150. By applying compression forces 140, piercer features 144 may punch through the compressed membrane layer 120 (and 136), which allows liquid 132 to be released from liquid well 124 and/or blister pack 142 into loading ports 118.

At a step 625, the liquid dispensing operation from the well-plate portion to the DMF portion is suspended by removing the compression force from the DMF device. For example, the liquid dispensing operation is suspended by removing the compression force from either DMF device 400 shown in FIG. 13 through FIG. 16 or two-piece DMF device 500 shown in FIG. 17 through FIG. 19. For example, FIG. 16 and FIG. 19 show an example of a process of removing the compression forces 140 and thereby suspending the liquid dispensing operation from well-plate portion 152 into DMF portion 150. By removing the compression forces 140, membrane layer 120 relaxes and piercer features 144 withdraw back into the relaxed membrane layer 120 and sealing loading ports 118, liquid well 124, and blister pack 142. Further, the relaxed membrane layer 120 retains all liquids and oil within DMF portion 150.

Referring now again to FIG. 13 through FIG. 19, the DMF device 400, two-piece DMF device 500, and method 600 may be an example of an arrangement of piercer features (e.g., piercer features 144) embedded in a compressible membrane layer (e.g., membrane layer 120) that may be used as the actuation mechanism for dispensing liquids therein.

### 1.7. DMF Piercer with Blister Pack and Two-Stage Actuation

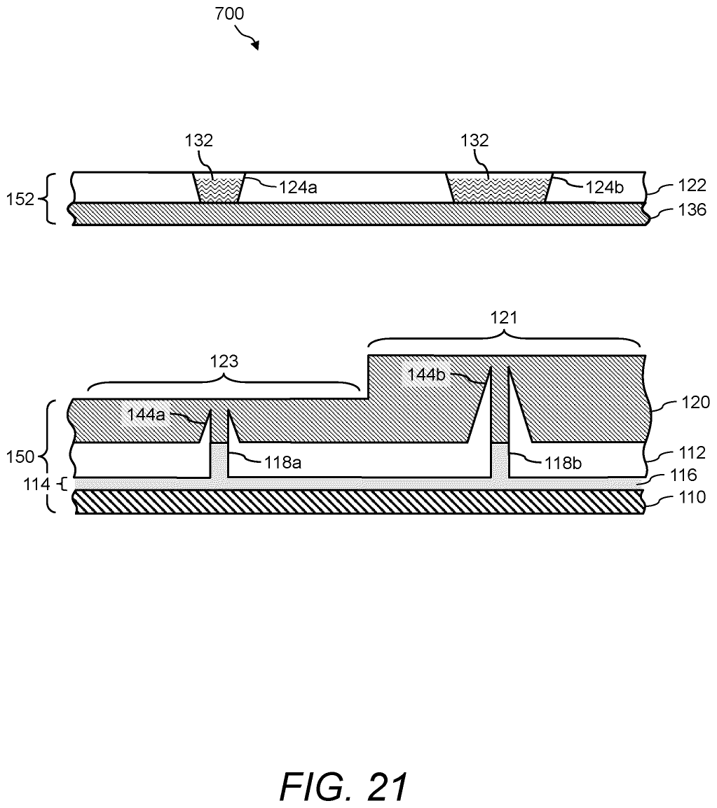

Referring now to FIG. 21 through FIG. 25 is side views of an example of a two-piece DMF device 700 including DMF piercer features embedded in a compressible membrane and a two-stage actuation process. Two-piece DMF device 700 may be substantially the same as two-piece DMF device 500 shown in FIG. 17 through FIG. 19 except that it includes two liquid wells 124 (e.g., 124a, 124b) in well plate 122 instead of one liquid well 124 and one blister pack 142. Further, in two-piece DMF device 700, the piercer features 144a that correlate with liquid well 124a and the piercer features 144b that correlate with liquid well 124b have different lengths (or heights). In one example, piercer features 144b are longer (or higher) than piercer features 144a. Accordingly, the thickness of membrane layer 120 may be different at piercer features 144b than at piercer features 144a. For example, there may be a step feature in membrane layer 120 located somewhere between piercer features 144a and 144b to form a thick portion 121 of membrane layer 120 at piercer features 144b and a thin portion 123 of membrane layer 120 at piercer features 144a.

In one example, piercer features 144a may be from about 0.9 mm to about 6 mm long or high. Accordingly, thin portion 123 of membrane layer 120 may be from about 1.1 mm to about 6.5 mm thick when uncompressed and from about 0.7 mm to about 5.5 mm thick when compressed. Further, in this example, piercer features 144b may be from about 4 mm to about 20 mm long or high. Accordingly, thick portion 121 of membrane layer 120 may be from about 4.5 mm to about 25 mm thick when uncompressed and from about 3.5 mm to about 18 mm thick when compressed.

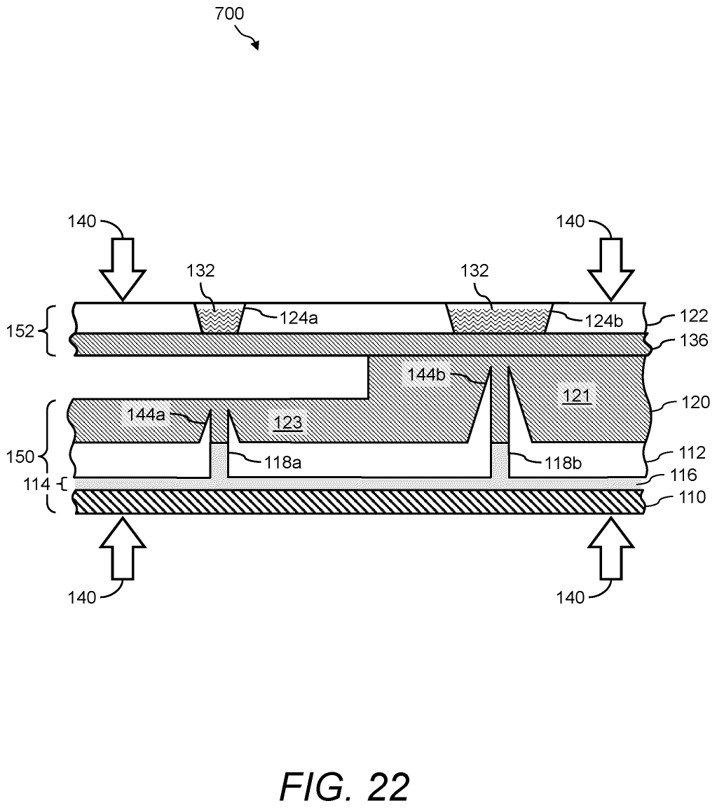

FIG. 22 through FIG. 25 show an example of a two-stage actuation process of dispensing liquid using the two-piece DMF device 700 shown in FIG. 21. For example, FIG. 22 shows DMF portion 150 and well-plate portion 152 mated together at membrane layers 120 and 136. FIG. 22 also shows compression forces 140 being applied to DMF portion 150 and/or well-plate portion 152 of two-piece DMF device 700.

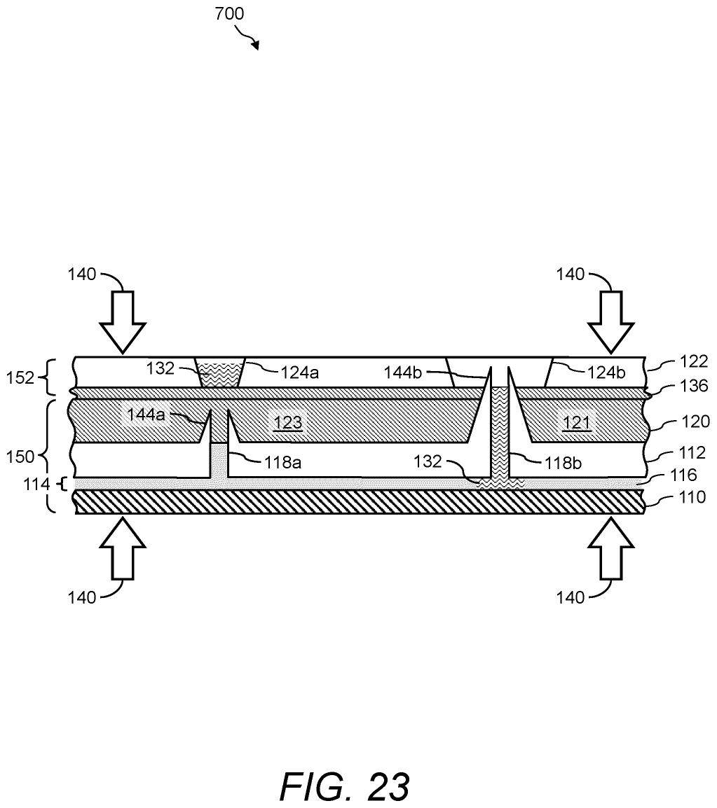

Next, in a first actuation step, FIG. 23 shows a certain amount of compression forces 140 being applied to DMF portion 150 and/or well-plate portion 152 of two-piece DMF device 700. In so doing, membrane layer 120 may be compressed a certain amount. For example, membrane layer 120 may be compressed in an amount that is about equal to the difference between the uncompressed thicknesses of thick portion 121 and thin portion 123. In this first actuation step, membrane layer 120 may be compressed such that the longer piercer features 144b may punch through the thick portion 121 of membrane layer 120 and into liquid well 124b. At the same time, the shorter piercer features 144a are still embedded and sealed within thin portion 123 of membrane layer 120. Accordingly, in this first actuation step, a liquid path is provided from liquid well 124b to loading port 118a. In this way, liquid 132 may be dispensed from liquid well 124b and into the droplet operations gap 114 of DMF portion 150, as shown here in FIG. 23. Further, in this first actuation step, liquid 132 is still retained in liquid well 124a and not yet dispensed.

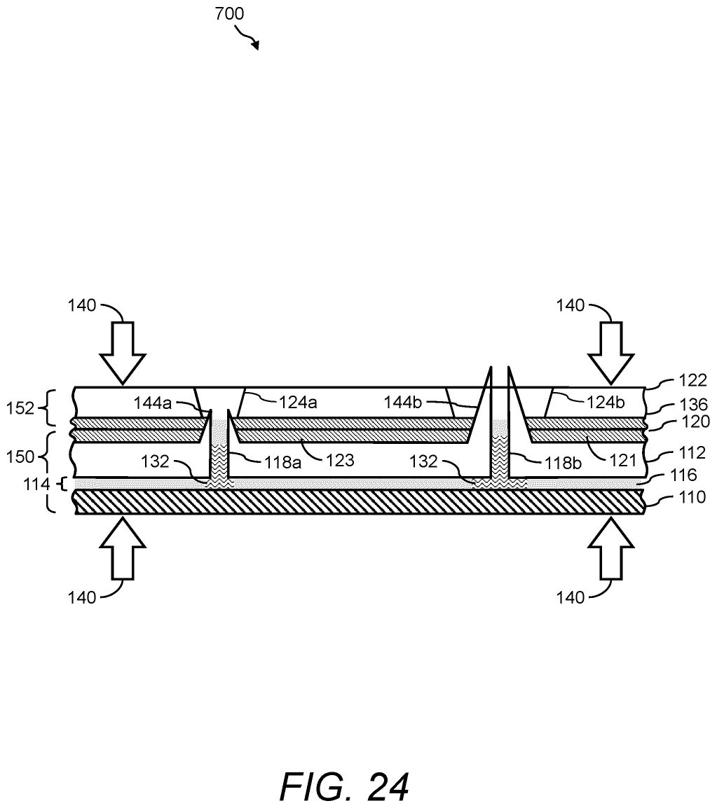

Next, in a second actuation step, FIG. 24 shows a certain additional amount of compression forces 140 being applied to DMF portion 150 and/or well-plate portion 152 of two-piece DMF device 700. In so doing, membrane layer 120 may be compressed a yet further amount. For example, in this second actuation step, membrane layer 120 may be compressed a further amount such that the shorter piercer features 144a may punch through the thin portion 123 of membrane layer 120 and into liquid well 124a. Accordingly, in this second actuation step, a liquid path is provided from liquid well 124a to loading port 118a. In this way, liquid 132 may be dispensed from liquid well 124a and into the droplet operations gap 114 of DMF portion 150, as shown here in FIG. 24. At the completion of this second actuation step, liquid 132 has been dispensed from both liquid wells 124a and 124b.

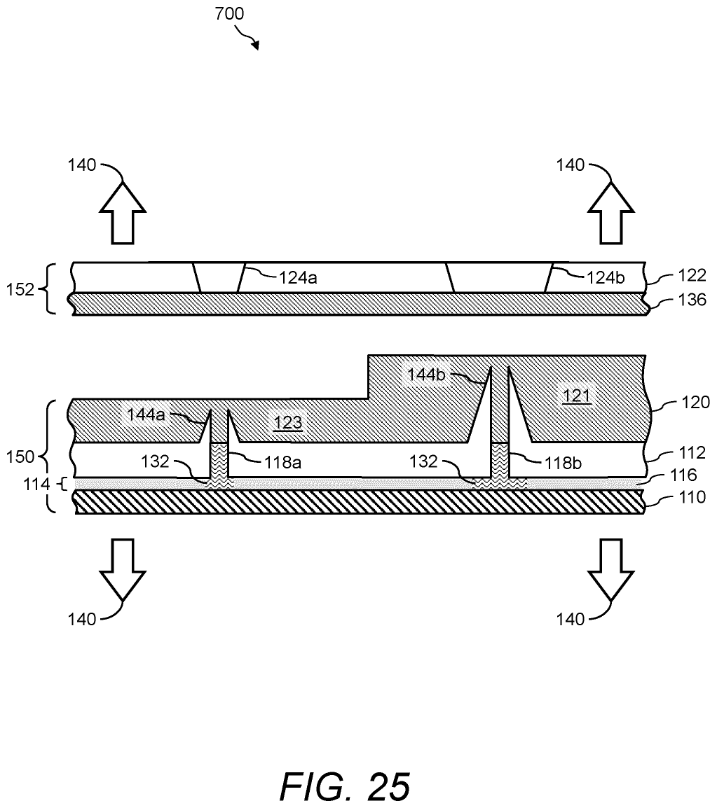

Next, upon completion of the two-stage liquid dispensing operation, FIG. 25 shows that compression forces 140 may be released from DMF portion 150 and/or well-plate portion 152 of two-piece DMF device 700. In so doing, membrane layer 120 may return to its relaxed or uncompressed state and piercer features 144a and 144b are now again embedded and sealed within membrane layer 120. Liquid 132 is now in droplet operations gap 114 of DMF portion 150 and ready to be processed. Further, the relaxed membrane layer 120 retains all liquids and oil within DMF portion 150.

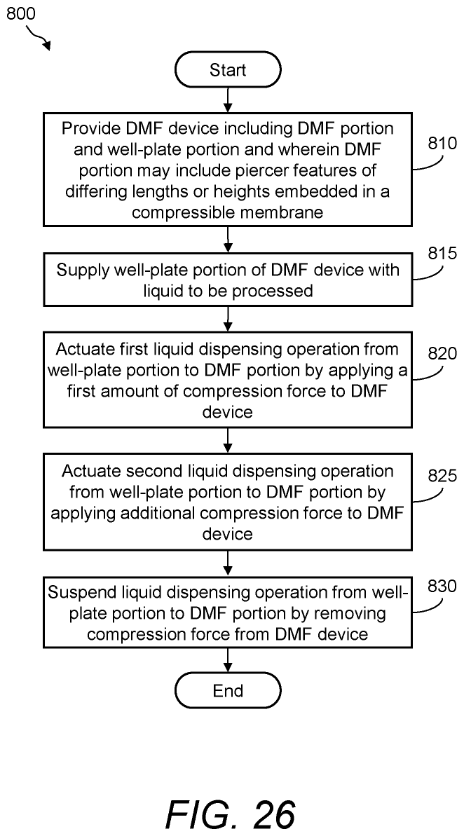

Referring now to FIG. 26 is a flow diagram of an example of a method 800, which is a two-stage actuation process of dispensing liquid using the two-piece DMF device 700 shown in FIG. 21 through FIG. 25. Method 800 may include, but is not limited to, the following steps.

At a step 810, a DMF device is provided that may include a DMF portion and a well-plate portion and wherein the DMF portion may include piercer features of differing lengths or heights embedded in a compressible membrane. In one example, the two-piece DMF device 700 shown in FIG. 21 through FIG. 25 is provided that may include DMF portion 150 and well-plate portion 152 and wherein DMF portion 150 may include the shorter piercer features 144a at loading port 118a and the longer piercer features 144b at loading port 118b. Further, the shorter piercer features 144a may be embedded in thin portion 123 of membrane layer 120 and the longer piercer features 144b may be embedded in thick portion 121 of membrane layer 120. Further, the shorter piercer features 144a and the longer piercer features 144b may be used to both pierce through membrane layer 120 and to provide a flow path between liquid wells 124a and 124b, respectively, of well-plate portion 152 and DMF portion 150.

At a step 815, the well-plate portion of the DMF device is supplied with liquid to be processed. For example, in two-piece DMF device 700 shown in FIG. 21 through FIG. 25, liquid wells 124 of well plate 122 of well-plate portion 152 may be filled with any type of liquid 132 to be processed, such as sample liquid, reagents, buffer solution, and the like. For example, FIG. 21 and FIG. 22 show both liquid wells 124a and 124b holding liquid 132.

At a step 820, a first liquid dispensing operation from the well-plate portion to the DMF portion is actuated by applying a first amount of compression force to the DMF device. For example, the first liquid dispensing operation is actuated by applying a first amount of compression force to two-piece DMF device 700, as shown, for example, in FIG. 23. In so doing, membrane layer 120 may be compressed just enough to release liquid 132 from liquid well 124b of well plate 122 of well-plate portion 152 into loading port 118b of DMF portion 150. Again, FIG. 23 shows an example of a process of using compression forces 140 to dispense liquid 132 from liquid well 124b into DMF portion 150. By applying a certain amount of compression forces 140, piercer features 144b may punch through the compressed thick portion 121 of membrane layer 120, which allows liquid 132 to be released from liquid well 124b into loading port 118b. Further, at the completion of this step 820, liquid 132 is still retained in liquid well 124a and not yet dispensed.

At a step 825, a second liquid dispensing operation from the well-plate portion to the DMF portion is actuated by applying additional compression force to the DMF device. For example, the second liquid dispensing operation is actuated by applying an additional amount of compression forces 140 to two-piece DMF device 700, as shown, for example, in FIG. 24. In so doing, membrane layer 120 may be compressed yet further to now release liquid 132 from liquid well 124a of well plate 122 of well-plate portion 152 into loading port 118a of DMF portion 150. Again, FIG. 24 shows an example of a process of using compression forces 140 to dispense liquid 132 from liquid well 124a into DMF portion 150. By applying an additional amount of compression forces 140, piercer features 144a may punch through the compressed thin portion 123 of membrane layer 120, which allows liquid 132 to be released from liquid well 124a into loading port 118a. Further, at the completion of this step 825, liquid 132 has been dispensed from both liquid wells 124a and 124b.

At a step 830, the liquid dispensing operation from the well-plate portion to the DMF portion is suspended by removing the compression force from the DMF device. For example, the liquid dispensing operation is suspended by removing the compression force from two-piece DMF device 700, as shown, for example, in FIG. 25. For example, FIG. 25 shows an example of a process of removing the compression forces 140 and thereby suspending the liquid dispensing operation from well-plate portion 152 into DMF portion 150. By removing the compression force, membrane layer 120 relaxes and piercer features 144a and 114b withdraw back into the relaxed membrane layer 120 and sealing loading ports 118a and 118b and liquid wells 124a and 124b. Further, the relaxed membrane layer 120 retains all liquids and oil within DMF portion 150.

Referring now again to FIG. 21 through FIG. 26, the two-piece DMF device 700 and method 800 may be an example of an arrangement of piercer features (e.g., piercer features 144) embedded in a compressible membrane layer (e.g., membrane layer 120) that may be used as the actuation mechanism for dispensing liquids therein.

Referring now again to FIG. 21 through FIG. 26, a benefit of two-piece DMF device 700 and method 800 is that the two-stage liquid dispensing operation may be particularly useful for conducting long experiments that use corrosive chemicals that could damage DMF portion 150 of two-piece DMF device 700 if held in-device for the entirety of the experiment. For example, while liquid 132 from liquid well 124b (the first dispense operation) has already been dispensed and is being processed in DMF portion 150, the corrosive chemicals may be held in liquid well 124a to be dispensed later using the second dispense operation.

Referring now again to FIG. 21 through FIG. 26, DMF portion 150 of two-piece DMF device 700 is not limited to two loading ports 118 only with piercer features 144. DMF device 100 may include any number and/or arrangements of loading ports 118 with piercer features 144. Further, two-piece DMF device 700 and method 800 is not limited to two different lengths or heights of piercer features 144 that provides two-stage actuation only. Two-piece DMF device 700 may be configured for multiple-stage actuation using piercer features 144 of multiple different lengths or heights. For example, when piercer features 144 are provided with three different lengths or heights, then three-stage actuation may be possible. When piercer features 144 are provided with four different lengths or heights, then four-stage actuation may be possible, and so on. Accordingly, method 800 may be modified for multiple-stage actuation.

### 1.8. Other Embodiments

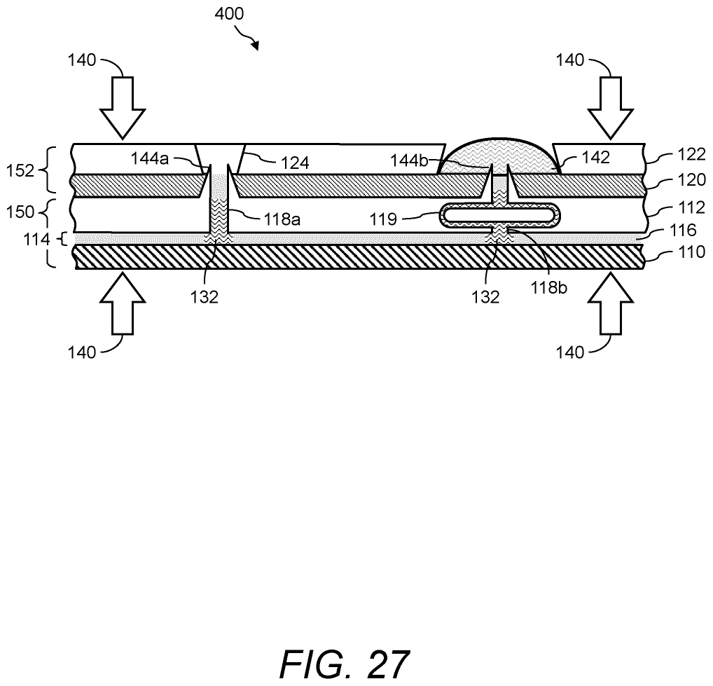

Referring now to FIG. 27 is a side view of an example of DMF device 400 configured for two-stage dispensing using a single-stage actuation process. In this example, loading port 118b of the DMF device 400 shown FIG. 13 through FIG. 16 may be modified to include an additional flow channel 119 in top substrate 112 of DMF portion 150. Loading port 118a provides a substantially direct flow path from liquid well 124 of well-plate portion 152 to droplet operations gap 114 of DMF portion 150. By contrast, the direct flow path of loading port 118b is uninterrupted by flow channel 119 for the purpose of extending the length of the flow path from, for example, blister pack 142. Therefore, by comparison, the flow path of loading port 118a is short while the flow path of loading port 118b is long. In this way, while both piercer features 144a and piercer features 144b act at the same time, a two-stage dispensing process may occur. That is, even though the flow from both liquid well 124 and blister pack 142 is initiated at substantially the same time (i.e., single-stage actuation), it will take longer for the liquid 132 from blister pack 142 to reach the droplet operations gap 114 than it takes the liquid 132 from liquid well 124 to reach the droplet operations gap 114 (i.e., two-stage dispensing). Accordingly, the timing of the two-stage dispensing operation may be determined by the difference between the two flow paths. In this example, the precise timing of the two-stage dispensing operation may be determined by setting the length and/or diameter (flow volume) of flow channel 119.

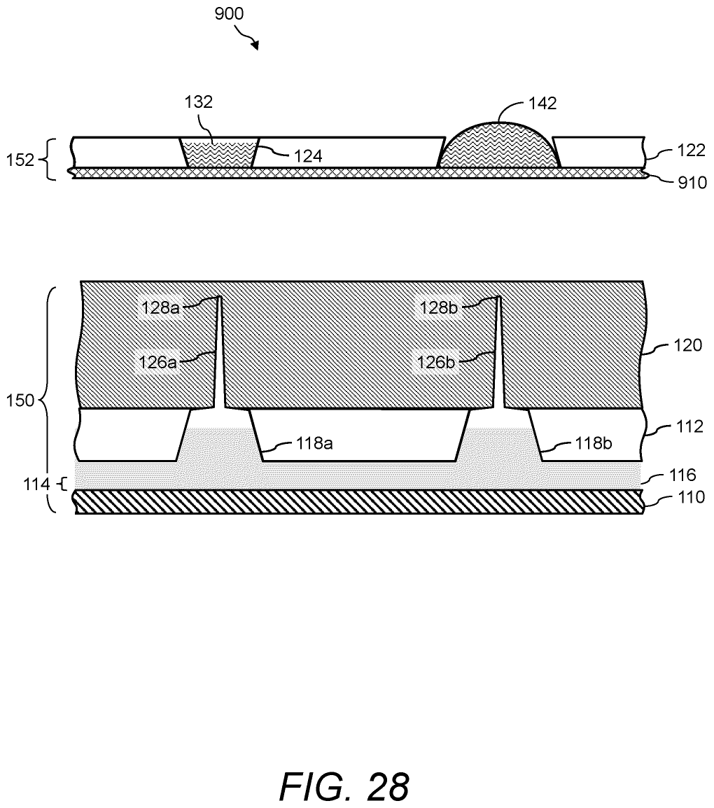

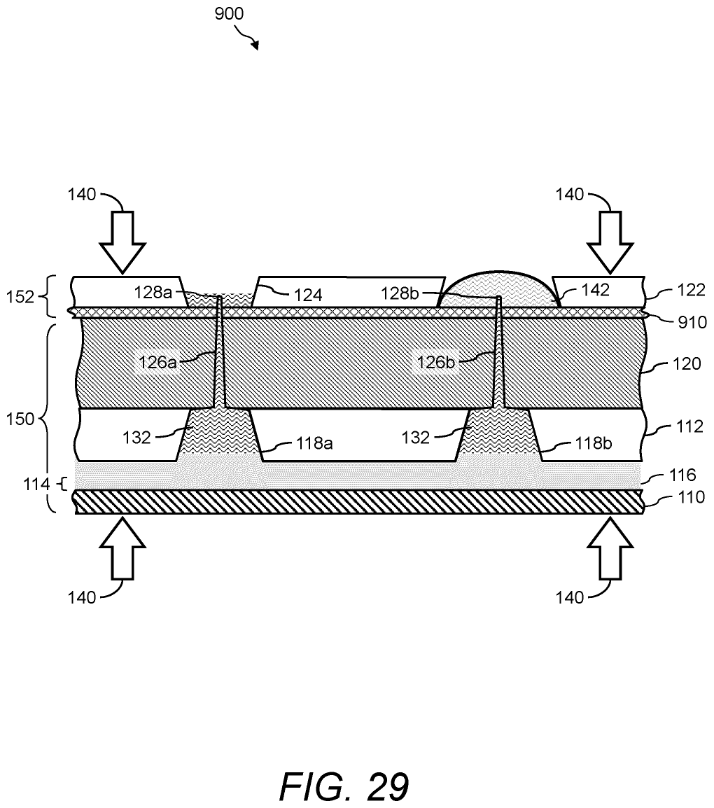

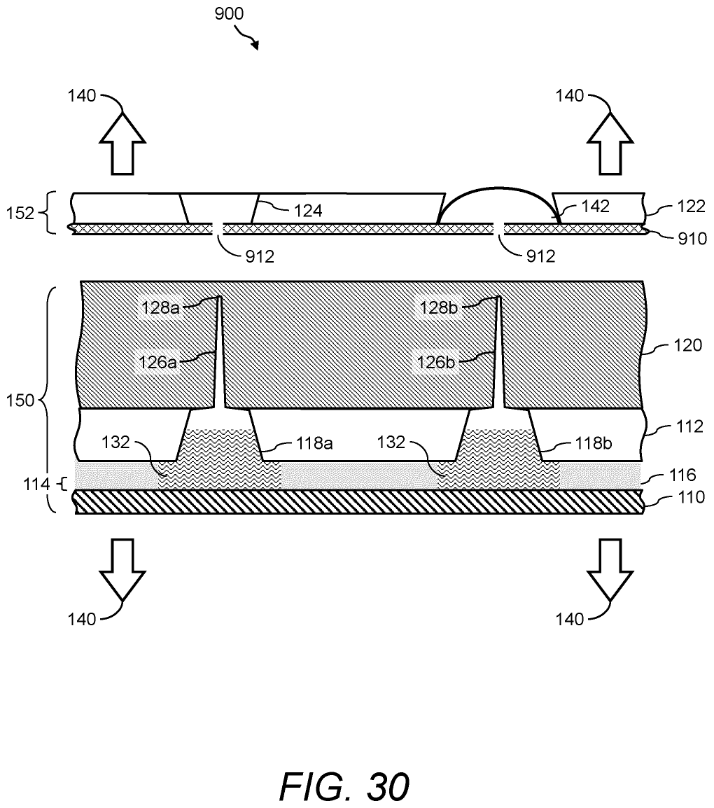

Referring now to FIG. 28, FIG. 29, and FIG. 30 is side views of an example of a two-piece DMF device 900 including DMF piercer features (e.g., needle features 126) embedded in a compressible membrane (e.g., membrane layer 120) and a process of using the same. In two-piece DMF device 900, one or more needle features 126 as described with reference to FIG. 1 through FIG. 11 may be provided in DMF portion 150. By contrast, in FIG. 1 through FIG. 11 the needle feature 126 is provided in well-plate portion 152.

In this example, a needle feature 126 may be configured as the inlet to a liquid port 118 with its opening 128 directed toward a liquid source in well-plate portion 152. For example, needle feature 126a may provide the inlet to liquid port 118a that may be supplied by liquid well 124 of well plate 122. Further, needle feature 126b may provide the inlet to liquid port 118b that may be supplied by blister pack 142. Further, needle features 126 may be embedded and sealed within membrane layer 120 when membrane layer 120 is in the uncompressed state. Additionally, in this example, instead of membrane layer 136 covering liquid well 124 and blister pack 142 of well plate 122, a frangible membrane 910 may be provided at well plate 122.

Frangible membrane 910 may be, for example, a foil and/or cellophane layer for sealing liquid well 124 and blister pack 142. However, at runtime frangible membrane 910 may be ruptured using needle features 126 so that liquid 132 may be released from liquid well 124 and blister pack 142 of well-plate portion 152 into DMF portion 150, as shown, for example, in FIG. 29, and FIG. 30. For example, compression forces 140 may be applied to DMF portion 150 and/or well-plate portion 152 of two-piece DMF device 900. In so doing, membrane layer 120 may be compressed such that needle features 126a and 126b may punch through membrane layer 120 and then punch through frangible membrane 910. In this way, liquid 132 may be released from liquid well 124 and blister pack 142 of well plate 122. Accordingly, needle features 126a and 126b may provide a flow path between DMF portion 150 and well-plate portion 152 of two-piece DMF device 900, as shown in FIG. 29.

Further, FIG. 30 shows that when compression forces 140 are released and DMF portion 150 and well-plate portion 152 are allowed to separate, puncture holes 912 may be left behind in frangible membrane 910, albeit with liquid 132 drained out of liquid well 124 and blister pack 142. In another example, in place of frangible membrane 910, two-piece DMF device 900 may include membrane layer 136 as described, for example, with reference to two-piece DMF device 500 shown in FIG. 17, FIG. 18, and FIG. 19. In this example, membrane layer 136 provides a resealable membrane at well-plate portion 152.

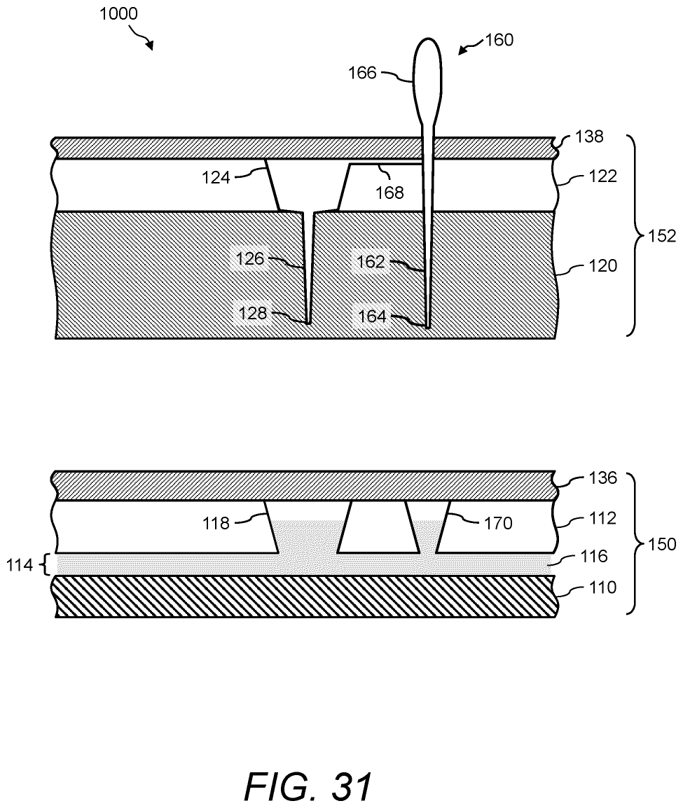

Referring now to FIG. 31 through FIG. 36 is side views of an example of a two-piece DMF device 1000 including DMF piercer features embedded in a compressible membrane and wherein two-piece DMF device 1000 may be configured for maintaining an airtight DMF environment. Two-piece DMF device 1000 may be substantially the same as two-piece DMF device 200 shown in FIG. 6 through FIG. 11 except that two-piece DMF device 1000 further includes a balloon device 160 in well-plate portion 152, a resealable membrane layer 138 atop well-plate portion 152, and a vent port 170 alongside the loading port 118 in top substrate 112 of DMF portion 150.

For example, FIG. 31 shows DMF portion 150 and well-plate portion 152 of two-piece DMF device 1000 in a separated state. Membrane layer 138 is provided atop well-plate 122 of well-plate portion 152. Membrane layer 138 may be formed of any rubber or elastomer compounds, as described with reference to membrane layers 120 and 136. Like membrane layers 120 and 136, membrane layer 138 may be compressible and may provide a resealable function atop well-plate portion 152.

Further, balloon device 160 may be provided alongside and a short distance away from liquid well 124 of well plate 122. Balloon device 160 may include, for example, a needle feature 162 that has an opening 164 at the distal tip thereof, and a balloon 166 atop and supplying needle feature 162. In this example, needle feature 162 of balloon device 160 may pass through membrane layer 138 and well-plate 122 and is embedded in membrane layer 120 when membrane layer 120 is in the uncompressed state, like needle feature 126 of liquid well 124. In one example, needle feature 162 of balloon device 160 may be slightly longer (e.g., about 1 mm longer) than needle feature 126. Further, an air channel 168 may be provided in well-plate 122. For example, air channel 168 runs between the upper edge of liquid well 124 and the upper end of needle feature 162 of balloon device 160. Air channel 168 allows, for example, air to pass between liquid well 124 and balloon 166 of balloon device 160. Further, needle feature 162 of balloon device 160 substantially aligns with vent port 170 in top substrate 112 of DMF portion 150. Accordingly, when DMF portion 150 and well-plate portion 152 of two-piece DMF device 1000 are compressed together, then opening 164 of needle feature 162 may enter vent port 170.

Referring still to FIG. 31, two-piece DMF device 1000 provides a 2-needle per well system where one needle (e.g., needle feature 162) provides the liquid transfer and the second needle (e.g., needle feature 162) provides air-release. Here, balloon device 160 may be used for air release to provide an air-tight system such that the user and (especially) the instrument is not exposed to the sample. This may be particularly interesting when considering biohazardous samples. Specifically, in two-piece DMF device 1000, the sample could be prepped on well-plate 122 of well-plate portion 152 in a biosafety cabinet (BSC), then sterilized. The preloaded well-plate portion 152 may then be run on an instrument outside of the BSC.

Again, well-plate portion 152 of two-piece DMF device 1000 may be sealed using membrane layer 138 and is airtight. In a workflow using two-piece DMF device 1000, the filler liquid 116 may be pre-filled. A main difference between, for example, two-piece DMF device 200 shown in FIG. 6 through FIG. 11 is the addition of a second small port (e.g., vent port 170) to one side of loading port 118 that may be used for air-release.

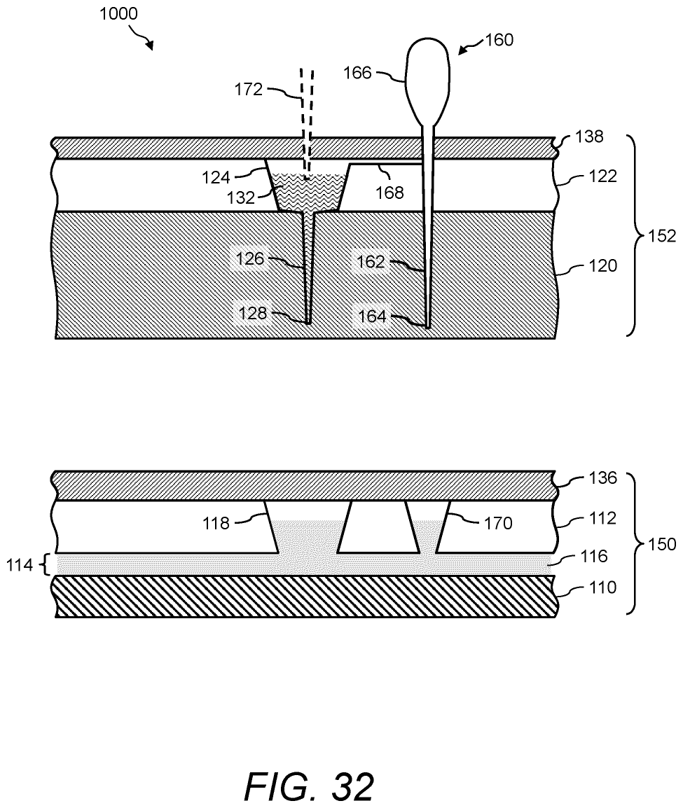

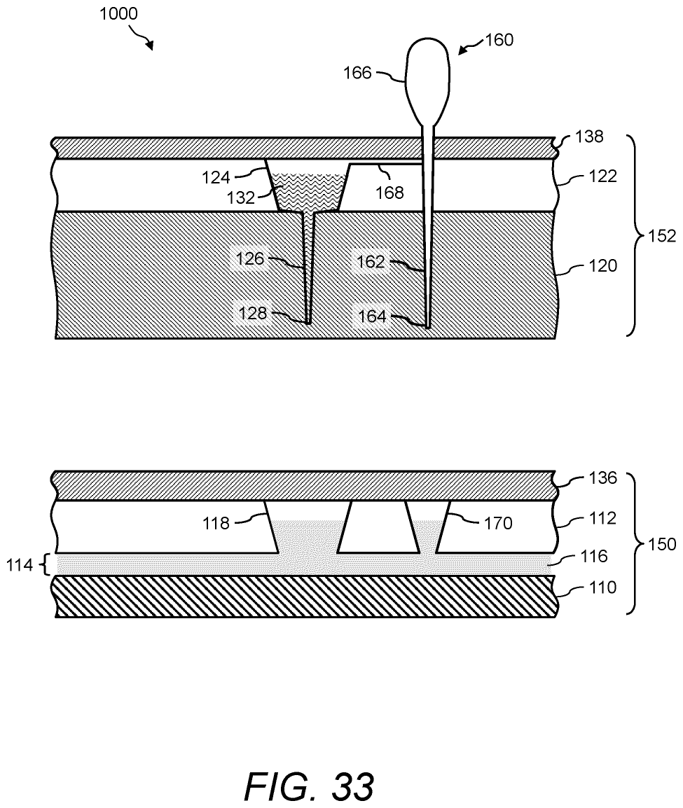

FIG. 32 through FIG. 36 show an example of using two-piece DMF device 1000. For example, FIG. 32 shows liquid well 124 of the separate well-plate portion 152 may, in one example, be provided pre-filled with liquid 132. In another example, liquid well 124 is not preloaded but instead loaded at runtime using a pipette tip or needle 172. Pipette tip or needle 172 may pass through membrane layer 138 to load liquid well 124. In yet another example, a lyophilized sample may be provided in liquid well 124 and then re-hydrated by the user introducing liquid at runtime. In any case, after using pipette tip or needle 172 to fill liquid well 124, pipette tip or needle 172 may be withdrawn from membrane layer 138 and wherein membrane layer 138 may reseal well-plate portion 152 to maintain an airtight and/or moisture tight DMF device, as shown in FIG. 33.

Referring still to FIG. 32 and FIG. 33, when filling liquid well 124, the air in liquid well 124 that is displaced by liquid 132 may enter (e.g., using air channel 168) and slightly inflate balloon 166 of balloon device 160. This may ensure that the introduction of liquid 132 does not aerosolize and is contained within well-plate portion 152. In other configurations, one balloon device 160 may be used to service more than one liquid well 124.

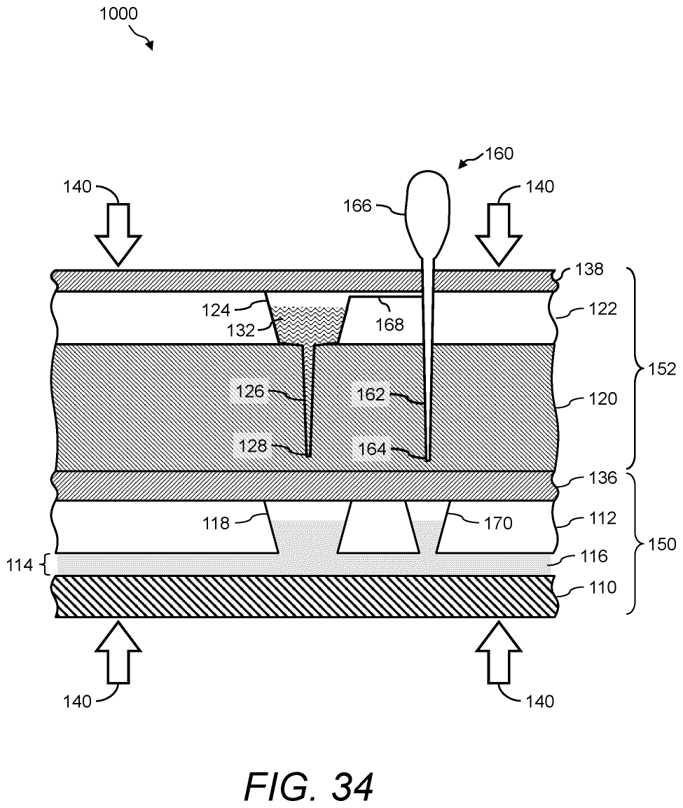

Next, FIG. 34 shows DMF portion 150 and well-plate portion 152 mated together with membrane layer 136 of DMF portion 150 against membrane layer 120 of well-plate portion 152. Also, FIG. 34 shows compression forces 140 being applied to DMF portion 150 and/or well-plate portion 152 of two-piece DMF device 1000.

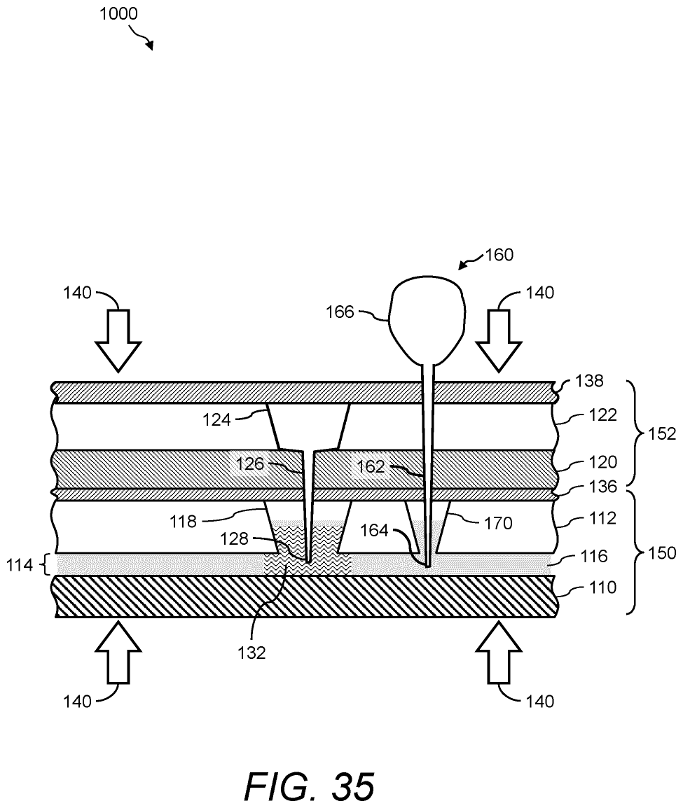

Next, FIG. 35 shows compression forces 140 being applied to DMF portion 150 and/or well-plate portion 152 of two-piece DMF device 1000. In so doing, membrane layer 120 may be compressed. In the process of compressing membrane layer 120, both needle feature 126 and needle feature 162 of balloon device 160 pierce through membrane layer 120. Accordingly, needle feature 126 enters loading port 118 and needle feature 162 of balloon device 160 enters vent port 170 of top substrate 112 in an unsealed fashion. In so doing, liquid 132 may be released from liquid well 124 of well plate 122 into loading port 118. Also, using vent port 170, air from droplet operations gap 114 may be vented into balloon 166 of balloon device 160. FIG. 35 shows balloon 166 of balloon device 160 yet further inflated.

Because all sides of two-piece DMF device 1000 are substantially airtight, it is important that balloon device 160 be present to relieve the air pressure. This is because the volume of liquid 132 pushed into DMF portion 150 must displace some air. This displaced air fills balloon 166. Further, because needle feature 162 of balloon device 160 may be slightly longer than needle feature 126, the air-pressure may be relieved via vent port 170 slightly before liquid 132 is introduced into loading port 118. Further, FIG. 35 shows that air channel 168 of well-plate 122 may also get compressed such that the only air-release may be from DMF portion 150.

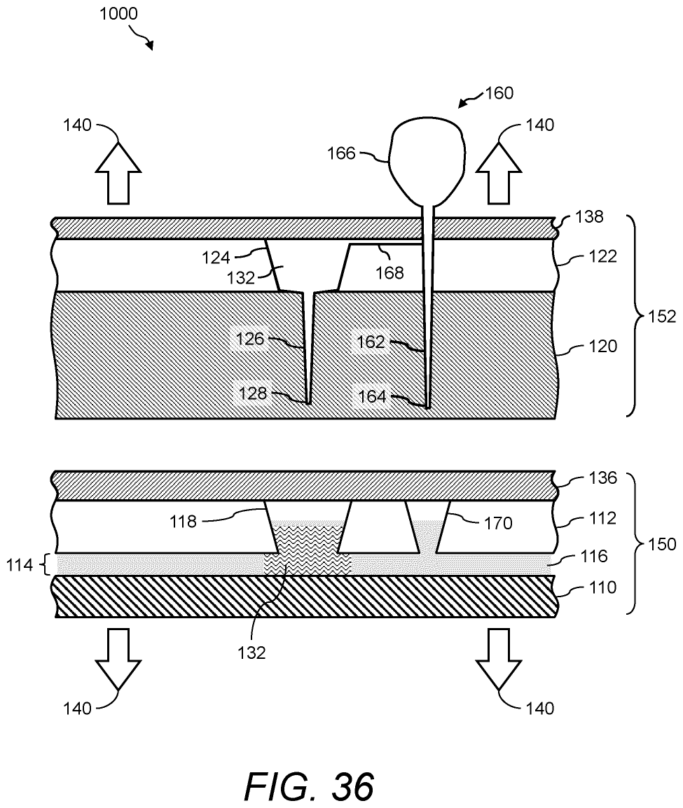

Next, upon completion of the liquid dispensing operation, FIG. 36 shows that compression forces 140 may be released from DMF portion 150 and/or well-plate portion 152 of two-piece DMF device 1000. In so doing, membrane layer 120 may return to its relaxed or uncompressed state and both needle feature 126 and needle feature 162 of balloon device 160 are now again embedded and sealed within membrane layer 120. Liquid well 124 of well plate 122 is now substantially empty of liquid 132. Liquid 132 is now in droplet operations gap 114 of DMF portion 150 and ready to be processed. Further, membrane layer 120 and membrane layer 138 maintain well-plate portion 152 in an airtight condition in which all liquids and oil may be fully contained. Likewise, DMF portion 150 is maintained airtight via membrane layer 136 and all liquids and oil may be fully contained.

Further, because DMF portion 150 and well-plate portion 152 of two-piece DMF device 1000 are fully sealed, the disposal of two-piece DMF device 1000 may be simplified. Further, it ensures that the instrument and instrument environment are un-contaminated.

Referring still to FIG. 31 through FIG. 36, other configurations of two-piece DMF device 1000 may be possible. In one example, instead of having one balloon 166 that is common to both liquid well 124 and vent port 170, each could have its own balloon.

In another example, balloon 166 at well-plate portion 152 is not connected to a needle. Instead, the needle may be provided at vent port 170 in DMF portion 150, as shown, for example, in two-piece DMF device 1000 of FIG. 28, FIG. 29, and FIG. 30. Then, when compression forces 140 are applied, the upward-facing needle of vent port 170 couples with balloon 166 at well-plate portion 152.

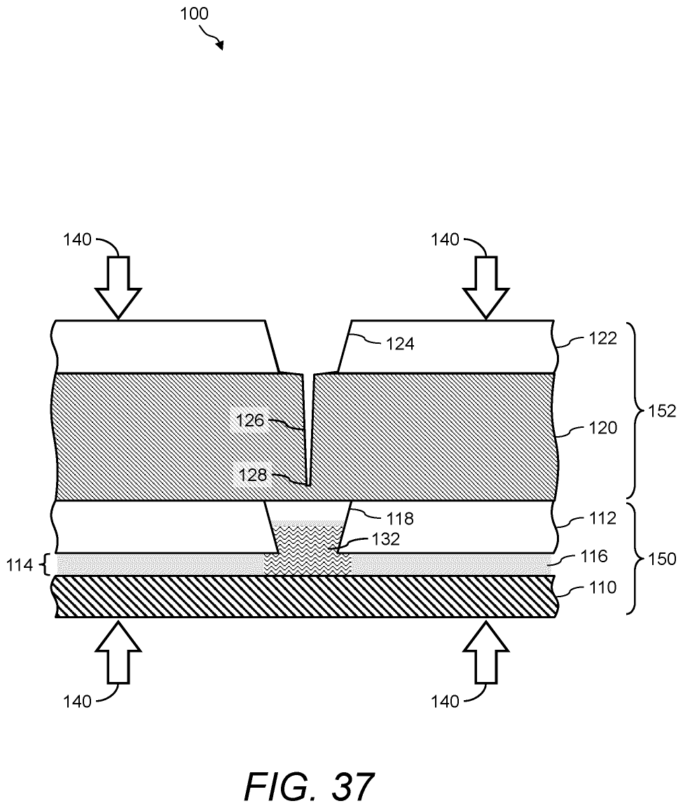

Referring now to FIG. 37 through FIG. 40 is side views of an example of a DMF device including DMF piercer features embedded in a compressible membrane and wherein the compressible membrane may be used for aspirating liquid instead of dispensing liquid. By way of example, DMF device 100 shown in FIG. 1 through FIG. 6 is described hereinbelow in FIG. 37 through FIG. 40 with respect to a process of aspirating liquid.

For example, FIG. 37 shows DMF device 100 with no compression forces 140 applied, membrane layer 120 in the uncompressed state, and liquid 132 present in droplet operations gap 114 at loading port 118 of DMF portion 150. Also, liquid well 124 and needle feature 126 of well-plate portion 152 are substantially empty of liquid.

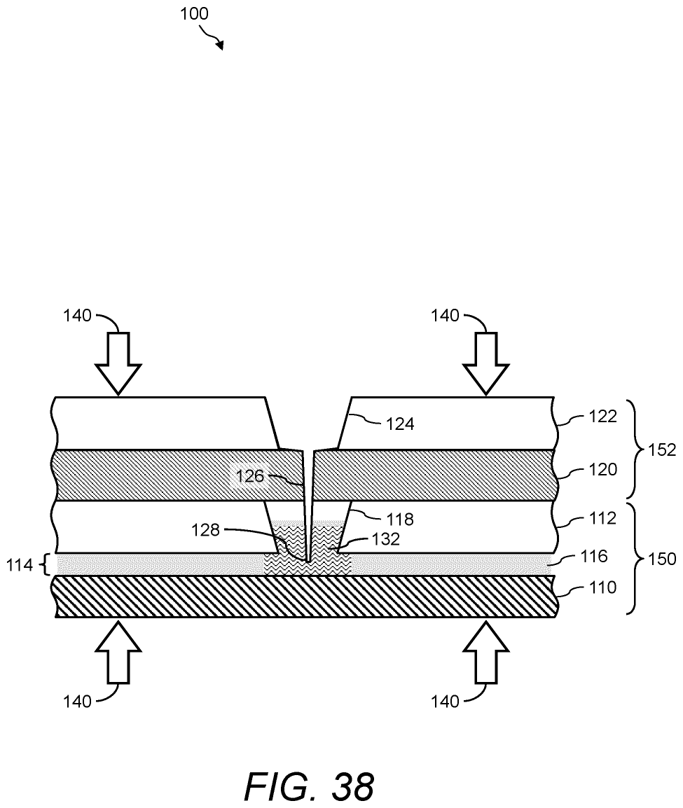

Next, FIG. 38 shows compression forces 140 may be applied, which places membrane layer 120 in the compressed state. In doing so, needle feature 126 punches through membrane layer 120 and enters loading port 118 and into liquid 132. In one example, the top of liquid well 124 may be left open in this step. In another example, rather than providing DMF device 100 in the uncompressed state as shown in FIG. 37, DMF device 100 may be provided already in the compressed state as shown here in FIG. 38.

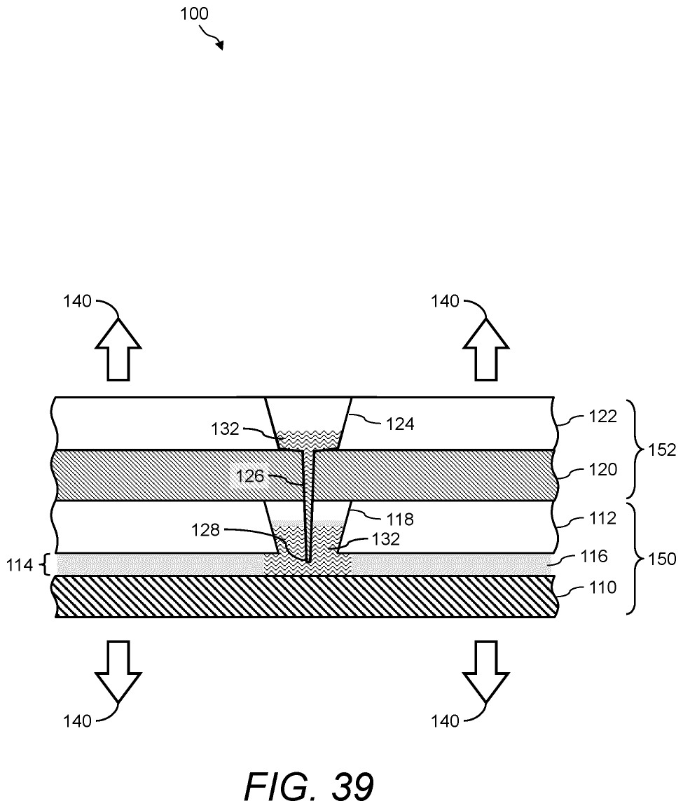

Next, FIG. 39 shows some amount of liquid 132 entering needle feature 126 and/or liquid well 124, then the top of liquid well 124 may be covered, and then compression forces 140 may be released.

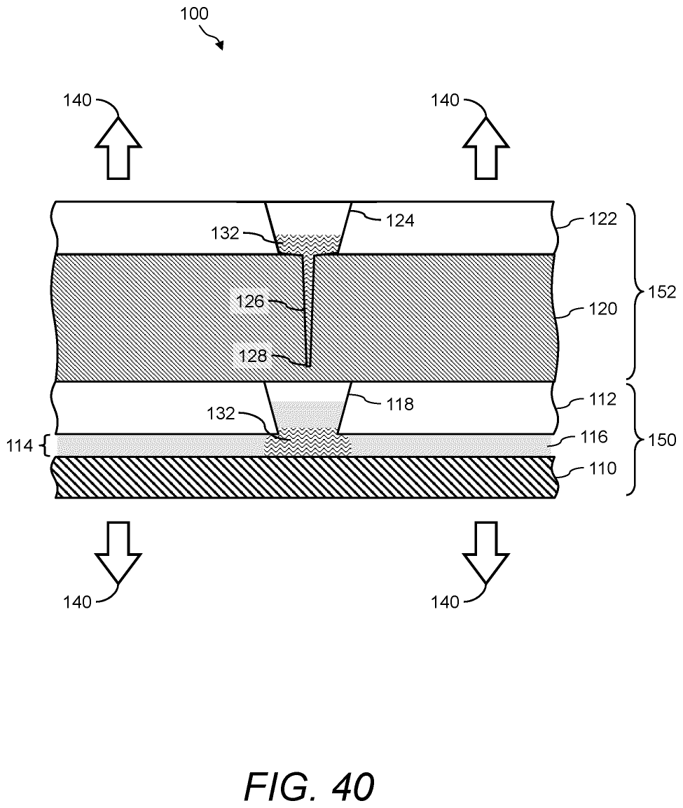

Next, FIG. 40 shows that compression forces 140 are released and membrane layer 120 returns to the uncompressed state. In the process of returning membrane layer 120 to the uncompressed state, a negative pressure develops in liquid well 124 and needle feature 126 and some amount of liquid 132 may be aspirated out of DMF portion 150 and into well-plate portion 152.

Referring now again to FIG. 1 through FIG. 40, the concepts described hereinabove may be somewhat combined. Furthermore, while compression forces (e.g., compression forces 140) may be used to actuate the various DMF devices, other actuation methods may be possible. For example, heat or electricity may be used to toggle valves, pneumatics may be used, and the like.

Referring now again to FIG. 1 through FIG. 40, while the compressible membrane layer (e.g., membrane layer 120) in which the piercer features (e.g., needle features 126, piercer features 144) may be embedded has been described as one thick membrane layer, in other embodiments, the compressible membrane layer may be formed of multiple layers. In one example, the compressible membrane layer may be a 2-layer rubber format, such as one low modulus layer to protect the piercer features and one higher modulus layer that provides the seal of the reagent area (e.g., well plate 122).

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the present disclosure.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the invention will be apparent to the skilled person without departing from the scope and spirit of the invention. Although the invention has been disclosed in connection with specific preferred aspects or embodiments, the invention as claimed should not be unduly limited to such specific aspects or embodiments.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact but may be approximate and/or larger or smaller as desired, reflecting tolerances, conversion factors, rounding off, measurement error and the like, and other factors known to those of skill in the art depending on the desired properties sought to be obtained by the subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

1. A cartridge comprising:
(a) a top substrate and a bottom substrate separated to form a droplet operations gap, the top substrate comprising a well plate comprising an array of wells each well comprising a hollow needle liquidly connecting an interior of the well with the droplet operations gap; and
(b) a compressible membrane layer atop the well plate sealing the reservoirs and arranged so that compression of the flexible membrane towards the interior of the well forces a liquid from the interior of the well through the hollow needle, and into the droplet operations gap.

2. A system comprising the cartridge of claim 1 mounted on an instrument, the instrument:
(a) comprising a means for compressing the flexible membrane;
(b) the means coupled to and controlled by a computer processor.

3. The cartridge of claim 1, wherein:
(a) one or more of the wells is pre-loaded with a liquid; and
(b) the liquid is sealed within the well by a sealing membrane.

4. The cartridge of any claim 3 wherein the liquid is selected from a group consisting of sample liquids, reagents, buffer solutions, or low-viscosity oils.

5. The system of claim 2, wherein the means for applying a compression force comprises a pressure plate or membrane.

6. The cartridge of claim 4, wherein the liquid comprises a low-viscosity oil selected from a group consisting of a silicone oil or a hexadecane filler liquid.

7. The cartridge of claim 1, wherein the droplet operations gap is pre-loaded with a low-viscosity oil.

8. The cartridge of claim 1, further comprising an adhesive bonding a bottom surface of the compressible membrane layer to a top surface of the top substrate and a top surface of the compressible membrane layer to a bottom surface of the well plate.

9. The cartridge according to claim 1, wherein the compressible membrane layer is from about 1 mm to about 25 mm thick when uncompressed and from about 0.7 mm to about 19 mm thick when compressed.

10. The cartridge according to claim 1, wherein the hollow needle is from about 0.9 mm to about 20 mm in length.

11. The cartridge according to claim 1, wherein the compressible membrane layer is composed of a rubber or elastomer compound.

12. The cartridge of claim 11, wherein the rubber or elastomer compound is selected from a group consisting of a natural rubber compound, a silicone rubber compound, butyl rubber compounds, ethylene propylene diene monomer (EPDM) compounds, nitrile rubber compounds, polychloroprene rubber compounds, fluorocarbon rubber compounds, and tetrafluoroethylene/propylene (TPE/P) rubber compounds.

13. The system of claim 5, wherein the cartridge is configured such that a compression force applied to the compressible membrane layer seals the wells while the compressible membrane layer is in a compressed state, thereby preventing the flow of liquid out of the droplet operations gap while the hollow needle is liquidly connected to the droplet operations gap.

14.-32. (canceled)

33. A cartridge comprising:
(a) a DMF component comprising:
(i) a bottom substrate and a top substrate, each having a bottom surface and a top surface, wherein the top substrate contains one or more openings through which a liquid can flow, whereon at least one of the openings is larger than the other openings;
(ii) one or more pairs of piercer features extending upwards from the top surface of the top substrate, wherein each pair of piercer features are separated by a gap, thereby forming a flow channel therethrough, and wherein the flow channels are in substantial alignment with the openings, and wherein at least one pair of piercer features is larger than the other piercer features;
(iii) a droplet operations gap interposed between the top surface of the bottom substrate and the bottom surface of the top substrate, thereby separating the bottom substrate and the top substrate to form a chamber in which droplet operations can be performed, wherein the flow channels are in liquid contact with the droplet operations gap via the openings; and
(iv) a first compressible membrane layer comprising a thick portion and a thin portion, each portion having a top surface and a bottom surface, and wherein the bottom surfaces of the thin portion and the thick portion are mounted on the top surface of the top substrate, a first compressible membrane layer comprising a thick portion and a thin portion, each portion having a top surface and a bottom surface, and wherein the bottom surfaces of the thin portion and the thick portion are mounted on the top surface of the top substrate, wherein the thick portion is substantially aligned with the larger piercer feature and the thin portion is substantially aligned with the other piercer features; and
(b) a well plate component comprising:
(i) a well plate with a bottom surface and a top surface, wherein the well plate comprises liquid wells in liquid contact with the top surface of the second compressible membrane layer, wherein one of the liquid wells is substantially aligned with the larger piercer feature and comprises a larger size, surface area, and volume that other liquid wells; and
(ii) a second compressible membrane layer having a top surface and a bottom surface, wherein the top surface of the second compressible membrane layer is mounted on the bottom surface of the well plate; and
wherein the DMF and well plate components are mated to form a single operational cartridge.

34. The cartridge of claim 33, further comprising a means for applying a first compression force and a second a compression force.

35. The cartridge of claim 34, wherein the means for applying the first compression force applies a first compression force to the thick portion of the first compressible membrane layer and the second compression force applies a second compression force to the thin portion of the first compression membrane layer.

36. The cartridge of claim 33, wherein the liquids are any liquids to be processed by the cartridge.

37. The cartridge according to claim 33, wherein in a first actuation stage, the larger piercer feature is arranged such that, upon actuation of the means for applying a first compression force and a second compression force, application of the first compression force causes the larger piercer feature to pass upwards through the thick portion of the first compressible membrane layer and the second compressible membrane layer and into the larger liquid well, thereby allowing liquid to flow through the flow channel into the droplet operations gap via the opening, and wherein in a second actuation stage, the other piercer features are arranged such that, upon actuation of the means for applying a first compression force and a second compression force, application of the second compression force causes the other piercer features to pass upwards through the thin portion of the first compression membrane layer and the second compression membrane layer and into other liquid wells, thereby allowing liquid to flow through the flow channels into the droplet operations gap via the openings;
wherein the liquid is sealed within the droplet operations gap when the DMF component and the well plate component of the single operational cartridge are separated.

38. (canceled)

39. A digital microfluidics cartridge comprising:
(a) a bottom substrate and a top substrate, each having a bottom surface and a top surface, wherein the top substrate comprises one or more liquid loading ports contained therein; and
(b) a droplet operations gap interposed between the top surface of the bottom substrate and the bottom surface of the top substrate, thereby separating the bottom substrate and the top substrate to form a chamber in which droplet operations can be performed, wherein the liquid loading ports are in liquid contact with the droplet operations gap; and
(c) a compressible membrane layer having a top surface and a bottom surface and comprising one or more hollow needle features each comprising an opening at the distal end of the hollow needle feature, wherein the hollow needle features protrude downward from the well plate portion and towards the DMF portion and wherein the openings are sealed while the compressible membrane layer is in an uncompressed state; and
(d) a well plate with a bottom surface and a top surface, wherein the well plate comprises liquid wells in liquid contact with the hollow needle features, wherein the bottom surface of the well plate is in contact with the top surface of the compressible membrane layer and wherein the liquid wells are in substantial alignment with the hollow needle features and the liquid loading ports.

40. The cartridge of claim 39, further comprising a means for applying a compression force, wherein the hollow needle feature is arranged such that, upon actuation of the means for applying a compression force, application of the compression force causes the hollow needle feature to pass through the compressible membrane layer and into the droplet operations gap, thereby permitting liquid to flow from the liquid wells into the droplet operations gap via the liquid loading ports, and wherein liquid is sealed within the droplet operations gap when the compressible membrane layer is returned to its uncompressed state.

41. (canceled)
